(19) United States
(12) Patent Application Publication
(10) Pub. No.: US 2021/0129524 A1
(43) Pub. Date: May 6, 2021

(54) PRINTED MATTER PRODUCING METHOD AND PRINTED MATTER PRODUCING APPARATUS

(71) Applicants: Yukio FUJIWARA, Kanagawa (JP); Yuuma USUI, Kanagawa (JP); Mikiko TAKADA, Kanagawa (JP); Masakazu YOSHIDA, Kanagawa (JP); Takuma NAKAMURA, Kanagawa (JP); Itsuki KAN, Kanagawa (JP)

(72) Inventors: Yukio FUJIWARA, Kanagawa (JP); Yuuma USUI, Kanagawa (JP); Mikiko TAKADA, Kanagawa (JP); Masakazu YOSHIDA, Kanagawa (JP); Takuma NAKAMURA, Kanagawa (JP); Itsuki KAN, Kanagawa (JP)

(21) Appl. No.: 17/080,148

(22) Filed: Oct. 26, 2020

(30) Foreign Application Priority Data
Oct. 30, 2019 (JP) 2019-197381
Oct. 12, 2020 (JP) 2020-172131

(51) Int. Cl. B41J 2/04; B41M 3/18; B41M 5/00

(52) U.S. Cl. CPC B41J 2/04; B41M 5/0011; B41M 3/18

(57) ABSTRACT

Provided is a printed matter producing method including: a volume expansion layer forming step of forming a volume expansion layer containing a volume expansion agent; a volume expansion suppressor applying step of applying and contacting a volume expansion suppressor containing a multifunctional monomer to the volume expansion layer while increasing an amount of the multifunctional monomer to be applied to a predetermined region of the volume expansion layer in accordance with a degree of suppressing volume expansion of the predetermined region of the volume expansion layer; and a volume expanding step of heating the volume expansion layer after the volume expansion suppressor applying step to volume-expand the volume expansion layer.

### CROSS-REFERENCE TO RELATED APPLICATIONS

This patent application is based on and claims priority pursuant to 35 U.S.C. § 119(a) to Japanese Patent Application Nos. 2019-197381 and 2020-172131, filed on Oct. 30, 2019 and Oct. 12, 2020, respectively, in the Japan Patent Office, the entire disclosure of each of which is hereby incorporated by reference herein.

### BACKGROUND

### Technical Field

The present disclosure relates to a printed matter producing method and a printed matter producing apparatus.

### Description of the Related Art

Materials such as floorings and wallpaper having desired images printed and design properties imparted by, for example, embossing have been used on, for example, floors, interior walls, and ceilings of buildings. Attempts have been made to improve durability of floorings and wallpaper through, for example, coating with ultraviolet (UV)-curable materials and coating with electron beam-curable materials.

Moreover, in recent years, techniques for inkjet-printing desired images on, for example, embossed floorings and wallpaper have been being developed. A method proposed as such a technique produces foamable wallpaper including a foamable layer, an image forming layer, and a surface protecting layer, wherein the foamable layer contains a thermoplastic resin and a foaming agent, and wherein the image forming layer and the surface protecting layer are crosslinkable or curable by electron beam irradiation.

A technique proposed as a technique relating to embossing produces a foamable sheet by chemical embossing, where the foamable sheet includes: a foamable resin layer formed of a foamable aqueous paint; a printed ink layer having a portion printed with a defoaming ink; and an ultraviolet-ray-curable layer, by chemical embossing.

In addition, a technique proposed as a chemical embossing method produces a decorative member by printing portions to be recessed (recessed portions) on a film of a foamable composition containing a polyvinyl chloride resin powder, a multifunctional vinyl monomer, and a foaming agent using an ink containing a defoaming agent such as trimellitic anhydride, and then forming a surface layer.

### SUMMARY

According to an aspect of the present disclosure, a printed matter producing method includes a volume expansion layer forming step of forming a volume expansion layer containing a volume expansion agent, a volume expansion suppressor applying step of applying and contacting a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer, and a volume expanding step of heating the volume expansion layer after the volume expansion suppressor applying step to volume-expand the volume expansion layer.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a schematic view illustrating an example of a printed matter producing apparatus of the present disclosure;

FIG. 2A is a diagram illustrating an example of a discharging amount of a volume expansion suppressor per unit area when the volume expansion suppressor is discharged in a uniform discharging amount per liquid droplet to a region that is to have a medium gradation;

FIG. 2B is a diagram illustrating an example distribution of a volume expansion suppressor when the volume expansion suppressor is discharged in a uniform discharging amount per liquid droplet to a region that is to have a medium gradation;

FIG. 3A is a diagram illustrating an example of a discharging amount of a volume expansion suppressor per unit area when the discharging amount of the volume expansion suppressor be discharged to a region that is to have a medium gradation is made nonuniform to vary the discharging amount of the volume expansion suppressor to be discharged to unit areas adjacent to each other;

FIG. 3B is a diagram illustrating an example distribution of a volume expansion suppressor when the discharging amount, per liquid droplet, of the volume expansion suppressor to be discharged to a region that is to have a medium gradation is made nonuniform to vary the discharging amount of the volume expansion suppressor between liquid droplets to be discharged adjacently to each other;

FIG. 4 is a schematic view illustrating an example of a printed matter producing apparatus of the present disclosure;

FIG. 5 is a graph plotting an example of a thickness profile of a region to which a volume expansion suppressor is applied and regions to which the volume expansion suppressor is not applied in a volume expansion layer of a printed matter 1 produced in Example 1;

FIG. 6 is a graph plotting an example of a thickness profile of a region to which a volume expansion suppressor is applied and regions to which the volume expansion suppressor is not applied in a volume expansion layer of a printed matter 3 produced in Example 3;

FIG. 7 is a graph plotting an example of a thickness profile of regions to which a volume expansion suppressor is applied and regions to which the volume expansion suppressor is not applied in a volume expansion layer of a printed matter 4 produced in Example 4;

FIG. 8 is a graph plotting an example of a thickness profile of regions to which a volume expansion suppressor is applied and regions to which the volume expansion suppressor is not applied in a volume expansion layer of a printed matter 5 produced in Example 5; and

FIG. 9 is a captured image of a cross-section of a printed matter 13 produced in Example 13 taken in a thickness direction.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a” “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

The present disclosure can provide a printed matter producing method that can produce a printed matter having a desired bossed-recessed shape.

### (Printed Matter Producing Method and Printed Matter Producing Apparatus)

A printed matter producing method of the present disclosure includes a volume expansion layer forming step of forming a volume expansion layer containing a volume expansion agent, a volume expansion suppressor applying step of applying and contacting a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer, and a volume expanding step of heating the volume expansion layer after the volume expansion suppressor applying step to volume-expand the volume expansion layer, preferably includes an image forming step, and further includes other steps as needed.

A printed matter producing apparatus of the present disclosure includes a volume expansion layer forming unit configured to form a volume expansion layer containing a volume expansion agent, a volume expansion suppressor applying unit configured to apply and contact a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer, a volume expanding unit configured to heat the volume expansion layer after the volume expansion suppressor applying unit applies the volume expansion suppressor to volume-expand the volume expansion layer, preferably includes an image forming unit, and further includes other units as needed.

The printed matter producing method of the present disclosure can be suitably performed by the printed matter producing apparatus of the present disclosure. The volume expansion layer forming step can be suitably performed by the volume expansion layer forming unit. The volume expansion suppressor applying step can be suitably performed by the volume expansion suppressor applying unit. The volume expanding step can be suitably performed by the volume expanding unit. The image forming step can be suitably performed by the image forming unit. A protecting layer forming step can be suitably performed by a protecting layer forming unit. Other steps can be suitably performed by other units.

The printed matter producing method of the present disclosure is based on the present inventors' finding that existing printed matter producing methods may not be able to impart an adequate bossed-recessed shape to a printed matter, and may not be able to impart an adequate design property based on the bossed-recessed shape.

Existing printed matter producing methods need embossing by a mold in order to impart a bossed-recessed shape, making small-lot production difficult and production costs high.

When volume-expanding (foaming) a volume expansion layer containing a volume expansion agent (foaming agent) in order to impart an arbitrary bossed-recessed shape to a printed matter, there is a need for controlling whether or not to volume-expand the volume expansion agent in an arbitrary region of the volume expansion layer. For this purpose, existing printed matter producing methods have suppressed volume expansion of the volume expansion layer by applying, for example, trimellitic anhydride serving as a volume expansion suppressor (defoaming agent) for suppressing volume expansion of the volume expansion agent over the volume expansion layer by, for example, gravure printing or rotary screen printing.

However, when a volume expansion agent having a high coefficient of volume expansion such as a thermally expansible microcapsule is used in the volume expansion layer, existing printed matter producing methods may have been unable to suppress volume expansion of the volume expansion agent and impart a desired bossed-recessed shape to the printed matters.

Moreover, existing printed matter producing methods may have been unable to accurately control the degree (extent or gradation) of volume expansion when volume-expanding the volume expansion layer and impart an adequate design property based on a bossed-recessed shape.

Hence, the present inventors have conducted earnest studies into, for example, a printed matter producing method that can produce a printed matter having a desired bossed-recessed shape, and conceived of the present disclosure. That is, the present inventors have found that a printed matter having a desired bossed-recessed shape can be produced by a printed matter producing method including a volume expansion layer forming step of forming a volume expansion layer containing a volume expansion agent, a volume expansion suppressor applying step of applying and contacting a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer, and a volume expanding step of beating the volume expansion layer after the volume expansion suppressor applying step to volume-expand the volume expansion layer.

In the printed matter producing method of the present disclosure, the volume expansion suppressor applying step applies and contacts a volume expansion suppressor containing a multifunctional monomer to the volume expansion layer.

A multifunctional monomer crosslinks three-dimensionally in response to application of energy when, for example, curing the material of the volume expansion layer in order to form the volume expansion layer. Therefore, in the volume expansion layer, the region to which the volume expansion suppressor containing the multifunctional monomer is applied and contacted is supposed to be more firmly cured. This suppresses volume expansion of the volume expansion agent during heating in the volume expanding step. Hence, by applying and contacting the volume expansion suppressor containing a multifunctional monomer to a predetermined region of the volume expansion layer, it is possible to accurately control volume expansion of the predetermined region.

Moreover, even when a volume expansion agent having a high coefficient of volume expansion such as a thermally expansible microcapsule is used in the volume expansion layer, the volume expansion suppressor containing a multifunctional monomer can suppress volume expansion of the volume expansion agent. With the ability to use a volume expansion agent having a high coefficient of volume expansion such as a thermally expansible microcapsule in the volume expansion layer, it is possible to form a bossed-recessed shape having sharpness (i.e., a large height difference between a recessed portion and a bossed portion) even when the volume expansion layer has a small thickness, making it possible to improve the design property of a printed matter.

In the printed matter producing method of the present disclosure, the volume expansion suppressor applying step applies and contacts a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer.

For example, the volume expansion suppressor applied and contacted to the volume expansion layer is considered to permeate the inside of the volume expansion layer. The ranges (depth and width) over which the applied volume expansion suppressor permeates the inside of the volume expansion layer are considered proportional to the amount of the volume expansion suppressor applied. Therefore, for example, in a region to which the volume expansion suppressor is applied in a larger amount, it is considered that the multifunctional monomer contained in the volume expansion suppressor spreads over a broader region inside the volume expansion layer and has a greater effect of suppressing volume expansion of the volume expansion agent. Hence, by increasing the amount of the multifunctional monomer to be applied (here, the amount of the volume expansion suppressor) in accordance with the degree of suppressing volume expansion of the predetermined region of the volume expansion layer, it is possible to control the degree of suppressing volume expansion of the predetermined region.

Also by increasing the concentration of the multifunctional monomer in the volume expansion suppressor to be applied to a predetermined region of the volume expansion layer, it is possible to increase the amount of the multifunctional monomer to be applied to the predetermined region. In this case, it is considered that a region inside the volume expansion layer reached by the multifunctional monomer is particularly firmly cured, and a greater effect of suppressing volume expansion of the volume expansion agent is exhibited in the region. Hence, by increasing the amount of the multifunctional monomer to be applied (here, the concentration of the multifunctional monomer in the volume expansion suppressor) in accordance with the degree of suppressing volume expansion of a predetermined region of the volume expansion layer, it is possible to control the degree of suppressing volume expansion of the predetermined region.

In this way, by increasing the multifunctional monomer to be applied to a predetermined region of the volume expansion layer in accordance with a desired degree of suppressing volume expansion of the predetermined region, it is possible to accurately control the degree (extent) of volume expansion of the predetermined region. More specifically, for example, the multifunctional monomer is applied in a small amount in a region desired to be slightly suppressed from volume expansion (i.e., a region desired to be a small recess), whereas the multifunctional monomer is applied in a large amount in a region not desired to have volume expansion (i.e. a region desired to be a large recess). In this way, it is possible to accurately control the degree of volume expansion of a predetermined region of the volume expansion layer, making it possible to, for example, control the thickness of the volume expansion layer to an arbitrary gradation at an arbitrary position and produce a printed matter having a desired bossed-recessed shape.

Moreover, the printed matter producing method of the present disclosure forms a volume expansion layer containing a volume expansion agent and volume-expands (foams) the volume expansion layer. In this way, the printed matter producing method of the present disclosure can impart a desired bossed-recessed shape easily to a printed matter.

Hence, the printed matter producing method of the present disclosure including the volume expansion layer forming step, the volume expansion suppressor applying step, and the volume expanding step can produce a printed matter having a desired bossed-recessed shape.

### <Volume Expansion Layer Forming Step and Volume Expansion Layer Forming Unit>

The volume expansion layer forming step is a step of forming a volume expansion layer (foamable layer) containing a volume expansion agent (foaming agent).

The volume expansion layer forming unit is a unit configured to form a volume expansion layer (foamable layer) containing a volume expansion agent (foaming agent).

The volume expansion layer forming unit is not particularly limited and may be appropriately selected depending on the intended purpose. Examples of the volume expansion layer forming unit include, but are not limited to, combination of a known material applying unit (e.g., a coating unit and a discharging unit) and a known energy applying unit (e.g., a thermal energy applying unit and an active energy ray irradiation unit).

The volume expansion layer forming step is not particularly limited so long as a volume expansion layer (foamable layer) can be formed. For example, it is preferable that the material applying unit apply a volume expansion layer forming liquid (foamable layer forming liquid) containing a volume expansion agent (foaming agent) over a base material to form a film, and then the energy applying unit cure the film to form a volume expansion layer. In other words, in the volume expansion layer forming step, it is preferable to form a volume expansion layer by applying a volume expansion layer forming liquid containing a volume expansion agent over a base material and then curing the volume expansion layer forming liquid.

The timing at which the volume expansion layer forming liquid is cured is not particularly limited and may be appropriately selected depending on the intended purpose so long as the timing is before the volume expanding step. For example, the timing may be after the volume expansion suppressor applying step or after the image forming step, or the volume expansion layer may be collectively cured with an image formed in the image forming step. Among these options, the timing at which the foamable layer forming liquid is cured is preferably after the volume expansion suppressor applying step.

That is, in the present disclosure, in the volume expansion layer forming step and the volume expansion suppressor applying step, it is preferable to form a volume expansion layer by applying a volume expansion suppressor over a layer formed of the volume expansion layer forming liquid and then curing the volume expansion layer forming liquid. This makes it possible to cure the multifunctional monomer contained in the volume expansion suppressor applied over the layer formed of the volume expansion layer forming liquid together with forming of the volume expansion layer, making it possible to more effectively suppress volume expansion of the volume expansion layer and produce a printed matter having a better bossed-recessed shape.

### <<Base Material>>

The base material over which the volume expansion layer forming liquid is applied is not particularly limited and may be appropriately selected depending on the intended purpose. Examples of the base material include, but are not limited to, resin films, sheets such as resin-impregnated paper, synthetic paper formed of synthetic fiber, natural paper, and nonwoven fabric, cloths, wooden boards, metallic plates, glass plates, ceramic plates, and building materials.

Examples of the resin films include, but are not limited to, polyester films, polypropylene films, polyethylene films, plastic films of nylon, vinylon, and acrylic, and pasted products of these films.

In terms of strength, uniaxially or biaxially stretched resin films are preferable.

The nonwoven fabric is not particularly limited and may be appropriately selected depending on the intended purpose. Examples of the nonwoven fabric include, but are not limited to, nonwoven fabric formed of polyethylene fibers sprinkled in a sheet shape and thermocompression-bonded with each other to obtain a sheet shape.

The wooden board is not particularly limited and may be appropriately selected depending on the intended purpose. Examples of the wooden board include, but are not limited to, plywoods such as MDF, HDF, particle boards, and veneers, and decorative laminates having pasted sheets over the surfaces. The thickness of the wooden board may be, for example, from 2 mm through 30 mm.

The glass plate is not particularly limited and may be appropriately selected depending on the intended purpose. Examples of the glass plate include, but are not limited to, float glass, colored glass, tempered glass, wire glass, ground glass, frosted glass, and mirror glass. The thickness of the glass plate may be, for example, from 0.3 mm through 20 mm.

The building material is not particularly limited and may be appropriately selected depending on the intended purpose. Examples of the building material include, but are not limited to, thermosetting resins, fiber boards, and particle boards used for, for example, flooring materials, wallpaper, interior materials, wall plate materials, baseboards, ceiling materials, and pillars, and decorative laminates of, for example, thermosetting resins, olefins, polyester, and PVC provided on the surfaces of the materials mentioned above.

### <<Volume Expansion Layer Forming Liquid>>

The volume expansion layer forming liquid (foamable layer forming liquid) contains a volume expansion agent (foaming agent), preferably contains a liquid composition, and further contains other components as needed.

### —Volume Expansion Agent—

The volume expansion agent (foaming agent) is not particularly limited and may be appropriately selected depending on the intended purpose so long as the volume expansion agent is a material that volume-expands when heated. Examples of the volume expansion agent include, but are not limited to, thermally expansible microcapsules, and thermally degradable foaming agents. Among these volume expansion agents, thermally expansible microcapsules are preferable because thermally expansible microcapsules have a high coefficient of thermal expansion and can form uniform, small independent cells.

A thermally expansible microcapsule is a particle having a core-shell structure encapsulating a volume expansion agent (foaming agent) with a thermoplastic resin. In response to heating, the thermoplastic resin constituting the outer shell starts to soften, and the vapor pressure of the encapsulated foamable compound rises to a pressure enough to deform the particle. As a result, the thermoplastic resin constituting the outer shell is drawn and expands the particle. Examples of the foamable compound include, but are not limited to, aliphatic hydrocarbons having low boiling points.

A commercially available product can be used as the thermally expansible microcapsule. Examples of the commercially available product include, but are not limited to, ADVANCELL EM SERIES available from Sekisui Chemical Co., Ltd., EXPANCELL DU, WU, MB, SL, and FG SERIES available from Akzo Nobel N.V. (sold by Japan Fillite Co., Ltd. in Japan), MATSUMOTO MICROSPHERE F and FN SERIES available from Matsumoto Yushi-Seiyaku Co., Ltd., and KUREHA MICROSPHERE H750, H850, and H1100 available from KUREHA Corporation. One of these commercially available products may be used alone or two or more of these commercially available products may be used in combination.

Examples of the thermally degradable foaming agent include, but are not limited to, organic foaming agents and inorganic foaming agents.

Examples of the organic foaming agent include, but are not limited to, azodicarboxylic acid amide (ADCA), azobisisobutyronitrile (AIBN), p,p′-oxybisbenzenesulfonyl hydrazide (OBSH), and dinitrosopentamethylene tetramine (DPT). One of these organic foaming agents may be used alone or two or more of these organic foaming agents may be used in combination.

Examples of the inorganic foaming agent include, but are not limited to, bicarbonates such as sodium hydrogen carbonate, carbonates, and combinations of bicarbonates and organic acid salts.

The content of the volume expansion agent in the volume expansion layer forming liquid is not particularly limited, may be appropriately selected depending on the intended purpose, and is preferably 1% by mass or greater but 20% by mass or less and more preferably 5% by mass or greater but 15% by mass or less relative to the total amount of the volume expansion layer forming liquid.

### —Liquid Composition—

The liquid composition is not particularly limited and may be appropriately selected depending on the intended purpose. Examples of the liquid composition include, but are not limited to, water, water-based organic solvents, oil-based organic solvents, and polymerizable solvents. The liquid composition may be selected depending on, for example, a liquid contact property with respect to the volume expansion agent (i.e., whether the liquid composition inhibits the foaming function by, for example, permeating the foaming agent). As the reference of the liquid contact property of the liquid composition, a SP value (solubility parameter) can be used. For example, it is preferable to select a liquid that has a SP value apart from the SP value of the volume expansion agent in order not to be compatibilized with the volume expansion agent.

The liquid composition serves as a dispersion medium of the volume expansion agent. When the liquid composition is a polymerizable solvent (polymerizable compound), the liquid composition can also serve as a constituent of the volume expansion layer. When the liquid composition is a liquid that is not a polymerizable solvent, it is preferable to further add a resin to the liquid composition so that the liquid composition can serve as a constituent of the volume expansion layer.

Examples of the water-based organic solvent include, but are not limited to, polyvalent alcohols such as methanol, ethanol, 1-propanol, 2-propanol, ethylene glycol, diethylene glycol, triethylene glycol, tetraethylene glycol, polyethylene glycol, propylene glycol, 1,3-propanediol, 2-methyl-1,3-propanediol, 1,4-butanediol, 1,5-pentanediol, 1,6-hexanediol, glycerin, 1,2,6-hexanetriol, 2-ethyl-1,3-hexanediol, 1,2,4-butanetriol, 1,2,3-butanetriol, and petriol; polyvalent alcohol alkylethers such as ethylene glycol monoethylether, ethylene glycol monobutylether, diethylene glycol monomethylether, diethylene glycol monoethylether, diethylene glycol monobutylether, triethylene glycol monobutylether, tetraethylene glycol monomethylether, and propylene glycol monoethylether; polyvalent alcohol arylethers such as ethylene glycol monophenylether and ethylene glycol monobenzylether; nitrogen-containing heterocyclic compounds such as N-methyl-2-pyrrolidone, N-hydroxyethyl-2-pyrrolidone, 2-pyrrolidone, 1,3-dimethyl imidazolidinone, and ε-caprolactam; amides such as formamide, N-methylformamide, and N,N-dimethylformamide; amines such as monoethanolamine, diethanolamine, triethanolamine, monoethylamine, diethylamine, and triethylamine; sulfur-containing compounds such as dimethylsulfoxide, sulfolane, and thiodiethanol; propylene carbonate; ethylene carbonate; γ-butyrolactone; and acetone.

Examples of the oil-based organic solvent when it is hydrocarbon include, but are not limited to dodecane, isododecane, hexadecane, isohexadecane, liquid paraffin, squalane, squalene, polybutene, polyisobutylene, cyclopentane, cyclohexane, polybutadiene, hydrogenated polybutadiene, polyisoprene, and hydrogenated polyisoprene.

Examples of the oil-based organic solvent when it is ester oil include, but are not limited to, isopropyl myristate, isopropyl palmitate, cetyl octanate, octyl dodecyl myristate, butyl stearate, hexyl laurate, myristyl myristate, decyl oleate, hexyl decyl dimethyloctanate, cetyl lactate, lanolin acetate, isocetyl stearate, isocetyl isostearate, di-2-ethylhexyl sebacate, di-2-hexyldecyl myristate, di-2-hexyldecyl palmitate, di-2-hexyldecyl adipate, and diisopropyl sebacate.

Examples of the oil-based organic solvent when it is higher fatty acid include, but are not limited to, isostearic acid, oleic acid, palmitic acid, lauric acid, myristic acid, behenic acid, linoleic acid, and linolenic acid. For example, oleic acid that is liquid at normal temperature is particularly preferable. Examples of the oil-based organic solvent when it is higher alcohol include but are not limited to, isostearyl alcohol, oleyl alcohol, octyl dodecanol cholesterol, stearyl alcohol, cetyl alcohol, decyl tetradecanol, hexyl decanol, behenyl alcohol, lauryl alcohol, lanolin alcohol, myristyl alcohol, and batyl alcohol. For example, oleyl alcohol that is liquid at normal temperature is particularly preferable.

Examples of the oil-based organic solvent when it is silicone include, but are not limited to, dimethyl polysiloxane, cyclomethicone, diphenyl polysiloxane, alkyl polysiloxane. Other examples of the oil-based organic solvent include, but are not limited to, compounds other than water-based organic solvents, such as methyl acetate, ethyl acetate, propyl acetate, butyl acetate, ethyl lactate, ethyl ethoxypropionate, butanol, normal hexane, cyclohexane methyl ethyl ketone, methyl isobutyl ketone, cyclohexanone, tetrahydrofuran, dioxane, toluene, ethyl benzene, acetophenone, and benzyl alcohol.

### —Polymerizable Solvent (Polymerizable Compound)—

The polymerizable solvent (polymerizable compound) is not particularly limited and may be appropriately selected depending on the intended purpose so long as the polymerizable solvent is a compound that can be polymerized when energy is applied. Examples of the polymerizable solvent include, but are not limited to, monofunctional monomers, multifunctional monomers, and combinations of monofunctional monomers and multifunctional monomers.

### —Monofunctional Monomer—

A monofunctional monomer contains, for example, one vinyl group, one acryloyl group, or one methacryloyl group in a molecular structure thereof.

Examples of the monofunctional monomer include, but are not limited to, γ-butyrolactone (meth)acrylate, isobornyl (meth)acrylate, formalized trimethylolpropane mono(meth)acrylate, trimethylolpropane (meth)acrylic acid benzoic acid ester, (meth)acryloylmorpholine, 2-hydroxylpropyl (meth)acrylamide, N-vinyl caprolactam, N-vinyl pyrrolidone, N-vinyl formamide, cyclohexane dimethanol monovinyl ether, hydroxyethyl vinyl ether, diethylene glycol monovinyl ether, dicyclopentadiene vinyl ether, tricyclodecane vinyl ether, benzyl vinyl ether, ethyloxetane vinyl ether, hydroxybutylhydroxyethyl vinyl ether, diethylene glycol monovinyl ether, dicycopentadiene vinyl eth vinyl ether, ethylvinyl ether, ethoxy(4)nonylphenol (meth)acrylate, benzyl (meth)acrylate, and caprolactone (meth)acrylate. One of these monofunctional monomers may be used alone or two or more of these monofunctional monomers may be used in combination.

Among these monofunctional monomers, isobornyl (meth)acrylate is preferable because isobornyl (meth)acrylate has a high glass transition temperature (Tg) and a good robustness.

The content of the monofunctional monomer is preferably 80% by mass or greater but 99.5% by mass or less and more preferably 90% by mass or greater but 95% by mass or less relative to the total amount of the curable composition.

### —Multifunctional Monomer—

A multifunctional monomer is a compound that contains, for example, two or more vinyl groups, two or more acryloyl groups, or two or more methacryloyl groups in a molecular structure thereof.

Examples of the multifunctional monomer include, but are not limited to, ethylene glycol di(meth)acrylate, hydroxypivalic acid neopentyl glycol di(meth)acrylate, polytetramethylene glycol di(meth)acrylate, diethylene glycol di(meth)acrylate, triethylene glycol di(meth)acrylate, tetraethylene glycol di(meth)acrylate, polyethylene glycol dimethacrylate [CH₂═CH—CO—(OC₂H₄)ₙ—OCOCH═CH₂ (n≈9), the same (n≈14), and the same (n≈23)], dipropylene glycol di(meth)acrylate, tripropylene glycol di(meth)acrylate, polypropylene glycol dimethacrylate [CH₂=C(CH₃)—CO—(OC₃H₆)ₙ—OCOC(CH₃)═CH₂ (n≈7)], 1,3-butanediol di(meth)acrylate, 1,4-butanediol di(meth)acrylate, 1,6-hexanediol di(meth)acrylate, 1,9-nonanediol di(meth)acrylate, neopentyl glycol di(meth)acrylate, tricyclodecane dimethanol di(meth)acrylate, propylene oxide-modified bisphenol A di(meth)acrylate, polyethylene glycol di(meth)acrylate, dipentaerythritol hexa(meth)acrylate, propylene oxide-modified tetramethylolmethane tetra(meth)acrylate, dipentaerythritol hydroxypenta(eth)acrylate, caprolactone-modified dipentaerythritol hydroxypenta(meth)acrylate, ditrimethylolpropane tetra(meth)acrylate, pentaerythritol tetra(meth)acrylate, trimethylolpropane tri(meth)acrylate, ethylene oxide-modified trimethylolpropane tri(meth)acrylate, propylene oxide-modified trimethylolpropane tri(meth)acrylate, caprolactone-modified trimethylolpropane tri(meth)acrylate, pentaerythritol tri(meth)acrylate, tris(2-hydroxyethyl)isocyanurate tri(meth)acrylate, ethoxylated neopentyl glycol di(meth)acrylate, propylene oxide-modified neopentyl glycol di(meth)acrylate, propylene oxide-modified glyceryl tri(meth)acrylate, polyester di(meth)acrylate, polyester tri(meth)acrylate, polyester tetra(meth)acrylate, polyester penta(meth)acrylate, polyester poly(meth)acrylate, polyurethane di(meth)acrylate, polyurethane tri(meth)acrylate, polyurethane tetra(meth)acrylate, polyurethane penta(meth)acrylate, polyurethane poly(meth)acrylate, triethylene glycol divinyl ether, cyclohexane dimethanol divinyl ether, diethylene glycol divinyl ether, triethylene glycol divinyl ether, and ethoxylated (4)bisphenol di(meth)acrylate. One of these multifunctional monomers may be used alone or two or more of these multifunctional monomers may be used in combination.

The [molecular weight] of the multifunctional monomer or the [number of functional groups] in the multifunctional monomer is preferably, for example, 250 or greater, because a design property (volume expansibility) and robustness can both be satisfied.

The content of multifunctional monomers and oligomers in the polymerizable compound is preferably 0.5% by mass or greater but 20% by mass or less and more preferably 5% by mass or greater but 10% by mass or less relative to the total amount of the polymerizable compound. When the content of multifunctional monomers and oligomers is 10% by mass or less, there is an advantage that a design property and robustness can both be satisfied.

The content of the polymerizable compound is not particularly limited, may be appropriately selected depending on the intended purpose, and is preferably 60% by mass or greater but 90% by mass or less and more preferably 70% by mass or greater but 85% by mass or less relative to the total amount of the volume expansion layer forming liquid. When the content of the polymerizable compound is 70% by mass or less, the volume expansion agent in the volume expansion layer can have an enhanced adhesiveness.

### —Other Components—

Other components in the volume expansion layer forming liquid is not particularly limited and may be appropriately selected depending on the intended purpose. Examples of the other components include, but are not limited to, a binder resin, a polymerization initiator, a filler, a foaming accelerator, a dispersant, a colorant, an organic solvent, an antiblocking agent, a thickener, a preservative, a stabilizer, a deodorant, a fluorescent agent, an ultraviolet screener, and a surfactant. Among these components, it is preferable to add a polymerization initiator when the liquid composition is a polymerizable solvent (polymerizable compound). It is preferable to add a binder resin when, for example, the liquid composition is not a polymerizable compound.

### —Binder Resin—

The binder resin is not particularly limited and may be appropriately selected depending on the intended purpose so long as the binder resin can support the foaming agent. Examples of the binder resin include, but are not limited to, water-soluble resins, emulsion resins, and other resins.

Examples of the water-soluble resin when it is of natural origin include, but are not limited to, vegetable polymers such as gum Arabic, gum tragacanth, guar gum, Karaya gum, locust bean gum, arabinogalactan, pectin, quince seed, and starch; seaweed polymers such as alginic acid, carrageenan, and agar; animal polymers such as gelatin, casein, albumin, and collagen; microbial polymers such as xanthan gum, and dextran or shellac. Examples of the water-soluble resin when it is semisynthetic include, but are not limited to, cellulose polymers such as methyl cellulose, ethyl cellulose, hydroxyethyl cellulose, hydroxypropyl cellulose, and carboxymethyl cellulose; starch polymers such as sodium starch glycolate and starch phosphoric acid ester sodium, and seewead polymers such as sodium alginate and alginic acid propylene glycol ester. Examples of the water-soluble resin when it is purely synthetic include, but are not limited to, vinyl-based polymers such as polyvinyl alcohol, polyvinyl pyrrolidone, and polyvinyl methyl ether; uncrosslinked polyacrylamide; polyacrylic acid and alkali metal salts of polyacrylic acid; acrylic-based resins such as water-soluble styrene-acrylic resins; water-soluble styrene-maleic acid resins; water-soluble vinyl naphthalene-acrylic resins; water-soluble vinyl naphthalene-maleic acid resins; and alkali metal salts of naphthalene sulfonic acid formalin condensate.

Examples of the emulsion resin include, but are not limited to, acrylic-based resins, vinyl acetate-based resins, styrene-butadiene-based resins, vinyl chloride-based resins, acrylic-styrene-based resins, butadiene-based resins, and styrene-based resins.

Examples of other resins that can be used as the binder resin include, but are not limited to, polyester resins and acrylic resins that are soluble in oil-based organic solvents.

### —Polymerization Initiator—

Examples of the polymerization initiator include, but are not limited to, thermal polymerization initiators and photopolymerization initiators. Among these polymerization initiators, photopolymerization initiators are more preferable in terms of a design property based on a bossed-recessed shape and durability of image quality.

It is preferable that the photopolymerization initiator produce active species such as a radical or a cation upon application of energy of an active energy ray and initiate polymerization of a polymerizable compound. As the polymerization initiator, it is suitable to use a known radical polymerization initiator, cation polymerization initiator, base generator, or a combination thereof. Of these, a radical polymerization initiator is preferable.

The polymerization initiator preferably accounts for 1 percent by weight to 20 percent by weight and more preferably accounts for 5 percent by weight to 15 percent by weight of the total amount of the curable composition to obtain sufficient curing speed.

Specific examples of the radical polymerization initiators include, but are not limited to, aromatic ketones, acylphosphine oxide compounds, aromatic onium chlorides, organic peroxides, thio compounds (thioxanthone compounds, thiophenyl group containing compounds, etc.), hexaaryl biimidazole compounds, ketoxime ester compounds, borate compounds, azinium compounds, metallocene compounds, active ester compounds, compounds having a carbon halogen bond(s), and alkyl amine compounds.

In addition, a polymerization accelerator (sensitizer) is optionally used together with the polymerization initiator.

The polymerization accelerator is not particularly limited. Examples of the polymerization accelerator include, but are not limited to, amine compounds such as trimethylamine, methyl dimethanolamine, triethanolamine, p-diethylaminoacetophenone, ethyl p-dimethylaminobenzoate, p-dimethylaminobenzoic acid-2-ethyl hexyl, N,N-dimethylbenzylamine, and 4,4′-bis(diethylamino)benzophenone.

The content of the polymerization accelerator may be appropriately set depending on the kind and the amount of the polymerization initiator used.

### —Surfactant—

A surfactant may be added in order to reduce surface tension for leveling adjustment during application over the base material and adjustment of spreading of the volume expansion suppressor.

Examples of the surfactant include, but are not limited to, glycerin fatty acid esters such as glycerin fatty acid ester, sorbitan fatty acid ester, fatty acid ester of polyethylene glycol, glyceryl monostearate, glyceryl monooleate, diglyceryl monostearate, and diglyceryl monoisostearate; glycol fatty acid esters such as propylene glycol monostearate; sorbitan fatty acid esters such as sorbitan monostearate and sorbitan monooleate; and sucrose stearic acid ester, POE (4.2) lauryl ether, POE (40) hydrogenated castor oil, POE (10) cetyl ether, POE (9) lauryl ether, POE (10) oleyl ether, POE (20) sorbitan monooleate, POE (6) sorbit monolaurate, POE (15) cetyl ether, POE (20) sorbitan monopalmitate, POE (15) oleyl ether, POE (100) hydrogenated castor oil, POE (20) POP (4) cetyl ether, POE (20) cetyl ether, POE (20) oleyl ether, POE (20) stearyl ether, POE (50) oleyl ether, POE (25) cetyl ether, POE (25) lauryl ether, POE (30) cetyl ether, and POE (40) cetyl ether. One of these surfactants may be used alone two or more of these surfactants may be used in combination.

The content of the surfactant is preferably, for example, 0.1% by mass or greater but 2% by mass or less relative to the total amount of the volume expansion layer forming liquid.

### —Filler—

Examples of the filler include, but are not limited to, aluminum hydroxide, magnesium hydroxide, barium hydroxide, calcium carbonate, magnesium carbonate, calcium sulfate, barium sulfate, ferrous hydroxide, basic zinc carbonate, basic lead carbonate, silica sand, clay, talc, silicas, titanium dioxide, and magnesium silicate. One of these fillers may be used alone or two or more of these fillers may be used in combination. Among these fillers, calcium carbonate, magnesium carbonate, aluminum hydroxide, and magnesium hydroxide are preferable.

### —Volume Expansion Accelerator—

The volume expansion accelerator (foaming accelerator) is not particularly limited and may be appropriately selected depending on the intended purpose. Examples of the volume expansion accelerator include, but are not limited to, zinc naphthenate, zinc acetate, zinc propionate, zinc 2-ethyl pentanoate, zinc 2-ethyl-4-methyl pentanoate, zinc 2-methyl hexanoate, zinc 2-ethyl hexanoate, zinc isooctylate, zinc n-octylate, zinc neodecanoate, zinc isodecanoate, zinc n-decanoate, zinc laurate, zinc myristate, zinc palmitate, zinc stearate, zinc isostearate, zinc 12-hydroxysterate, zinc behenate, zinc oleate, zinc linoleate, zinc linolenate, zinc ricinoleate, zinc benzoate, zinc o, m, or p-toluate, zinc p-t-butyl benzoate, zinc salicylate, zinc phthalate, zinc salt of phthalic acid monoalkyl (C4 to C18) ester, zinc dehydroacetate, zinc dibutyl dithiocarbamate, zinc aminocrotonate, zinc salt of 2-mercaptobenzothiazole, zinc pyrithione, and zinc complex of urea or diphenylurea. One of these volume expansion accelerators may be used alone or two or more of these volume expansion accelerators may be used in combination.

### —Thickener—

Examples of the thickener include, but are not limited to, polycyanoacrylate, polylactic acid, polyglycolic acid, polycaprolactone, polyacrylic acid alkyl ester, and polymethacrylic acid alkyl ester.

### —Preservative—

Examples of the preservative include, but are not limited to, substances that have been hitherto used and do not initiate polymerization of a monomer, such as potassium sorbate, sodium benzoate, sorbic acid, and chlorocresol.

### —Stabilizer—

The stabilizer serves to, for example, suppress polymerization of a monomer under storage. Examples of the stabilizer include, but are not limited to, anionic stabilizers and free radical stabilizers.

Examples of the anionic stabilizer include, but are not limited to, metaphosphoric acid, maleic acid, maleic anhydride, alkyl sulfonic acid, phosphorus pentoxide, iron (III) chloride, antimony oxide, 2,4,6-trinitrophenol, thiol, alkyl sulfonyl, alkyl sulfone, alkyl sulfoxide, alkyl sulfite, sulton, sulfur dioxide, and sulfur trioxide.

Examples of the free radical stabilizer include, but are not limited to, hydroquinone, and catechol, or derivatives thereof.

The volume expansion layer forming liquid used in the present disclosure can be produced by using the various components described above. The preparation devices and conditions are not particularly limited. For example, the volume expansion layer forming liquid can be prepared by subjecting the volume expansion agent, the liquid composition, etc., to a dispersion treatment using a dispersing machine such as a ball mill, a kitty mill, a disk mill, a pin mill, and a DYNO-MILL, and further mixing the resultant with a polymerization initiator, a surfactant, etc.

The viscosity of the volume expansion layer forming liquid is not particularly limited, may be appropriately selected depending on the intended purpose, and is preferably 50 mPa·s or higher but 10,000 mPa·s or lower and more preferably 100 mPa·s or higher but 7,000 mPa·s or lower at 25 degrees C. When the viscosity of the volume expansion layer forming liquid at 25 degrees C. is 50 mPa·s or higher but 10,000 mPa·s or lower, it is possible to improve qualities such as permeability of the volume expansion suppressor in the volume expansion layer and uniformity of the volume expansion layer.

The viscosity of the volume expansion layer forming liquid can be measured with, for example, a rheometer MCR301 available from Anton Paar GmbH and a cone plate CP25-1 at a shear rate of 10/s at 25 degrees C.

The static surface tension of the volume expansion layer forming liquid is not particularly limited, may be appropriately selected depending on the intended purpose, and is preferably 15 mN/m or higher but 50 mN/m or lower at 25 degrees C. In the following description, the static surface tension of the volume expansion layer forming liquid at 25 degrees C. may be referred to as “static surface tension A”.

The static surface tension of the volume expansion layer forming liquid can be measured with, for example, an automatic surface tensiometer DY-300 available from Kyowa Interface Science, Inc. according to a plate method or a ring method.

The method for applying the volume expansion layer forming liquid over a base material is not particularly limited and may be appropriately selected depending on the intended purpose. Examples of the method include, but are not limited to, coating methods such as a knife coating method, a nozzle coating method, a die coating method, a lip coating method, a comma coating method, a gravure coating method, a rotary screen coating method, a reverse roll coating method, a roll coating method, a spin coating method, a kneader coating method, a bar coating method, a blade coating method, a casting method, a dipping method, and a curtain coating method, and an inkjet method.

In the present disclosure, it is preferable to form the volume expansion layer by applying the volume expansion layer forming liquid (foamable layer forming liquid) containing a volume expansion agent (foaming agent) and a polymerizable solvent (polymerizable compound) serving as the liquid composition over a base material and subsequently curing the volume expansion layer forming liquid.

The method for curing the volume expansion layer forming liquid when curing the volume expansion layer forming liquid is not particularly limited and may be appropriately selected depending on the intended purpose. For example, curing may be performed by an energy applying step.

The energy applying step is a step of applying energy to a target layer, and can be performed by, for example, an energy applying unit.

Examples of the energy include, but are not limited to, thermal energy and active energy rays.

When the energy is thermal energy, for example, the volume expansion layer may be cured and volume-expanded at the same time by application of thermal energy to the volume expansion layer. In other words, the volume expanding step may be performed collectively when applying thermal energy to the curable composition to cure the curable composition. Moreover, by applying thermal energy to the volume expansion layer, it is possible to three-dimensionally crosslink the region to which the volume expansion suppressor is applied in the volume expansion suppressor applying step.

The unit configured to apply thermal energy is not particularly limited and may be appropriately selected depending on the intended purpose. Examples of the unit include, but are not limited to, infrared heaters, hot air heater, and heating rollers.

The heating temperature by application of thermal energy is not particularly limited and may be appropriately selected depending on the intended purpose so long as the foamable layer can be thermally cured, and is preferably higher than or equal to the thermal decomposition temperature of the foaming agent, and is preferably, for example, 100 degrees C. or higher but 200 degrees C. or lower.

When the energy is active energy rays, for example, the volume expansion layer (foamable layer) is cured by irradiation of the volume expansion layer with active energy rays.

### —Active Energy Rays—

Active energy rays are not particularly limited, so long as they are able to give necessary energy for allowing polymerization reaction of polymerizable components in the composition to proceed. Examples of the active energy rays include, but are not limited to, electron beams, α-rays, β-rays, γ-rays, and X-rays, in addition to ultraviolet rays. When a light source having a particularly high energy is used, polymerization reaction can be allowed to proceed without a polymerization initiator. In addition, in the case of irradiation with ultraviolet ray, mercury-free is preferred in terms of protection of environment. Therefore, replacement with GaN-based semiconductor ultraviolet light-emitting devices is preferred from industrial and environmental point of view. Furthermore, ultraviolet light-emitting diode (UV-LED) and ultraviolet laser diode (UV-LD) are preferable as an ultraviolet light source. Small sizes, long time working life, high efficiency, and high cost performance make such irradiation sources desirable.

The curing conditions are not particularly limited and may be appropriately selected depending on the intended purpose. In the case of ultraviolet rays, an irradiator that can emit an intensity of 6 W/cm or higher from an irradiation distance of 2 mm is preferable.

In the case of electron beams, an accelerating voltage that gives a dose of 15 kGy or higher to a farthest position of the curing target from the electron beam irradiator is preferable.

The average thickness of the volume expansion layer (before volume expansion) is not particularly limited, may be appropriately selected depending on the intended purpose, and is preferably 50 micrometers or greater, more preferably 100 micrometers or greater, yet more preferably 250 micrometers or greater, and particularly preferably 300 micrometers or greater but 500 micrometers or less.

When the average thickness of the volume expansion layer (before volume expansion) is 50 micrometers or greater, a volume expansion layer having a height difference can be formed and a more desirable bossed-recessed shape can be imparted.

The average thickness of the volume expansion layer after volume expansion is not particularly limited, may be appropriately selected depending on the intended purpose, and is preferably 100 micrometers or greater, more preferably 310 micrometers or greater, yet more preferably 400 micrometers or greater, and particularly preferably 400 micrometers or greater but 2,000 micrometers or less.

When the average thickness of the volume expansion layer after volume expansion is 100 micrometers or greater, a volume expansion layer having a height difference attributable to the volume expansion suppressor can be formed and a more desirable bossed-recessed shape can be imparted.

The average thickness can be obtained by scraping the volume expansion layer at different ten positions, measuring the height of the scraped portions from the base material to the surface of the volume expansion layer with, for example, a laser microscope VK-X100 available from Keyence Corporation, and calculating the average of the measured heights.

In the volume expansion layer used in the present disclosure, the average thickness, after volume expansion, of a volume-expanded region (i.e., a region to which the volume expansion suppressor is not applied) of the volume expansion layer, i.e., a volume expansion magnification is 1.1 or more times greater than the average thickness before volume expansion. The volume expansion magnification of the volume expansion layer is not particularly limited and may be appropriately selected depending on the intended purpose, so long as it is 1.1 or more times, and is preferably 1.3 or more times and more preferably 2 or more times. A volume expansion layer having a volume expansion magnification of 1.3 or more times can more securely have a height difference and a desirable bossed-recessed shape.

### <Volume Expansion Suppressor Applying Step and Volume Expansion Suppressor Applying Unit>

The volume expansion suppressor applying step is a step of applying and contacting a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer.

The volume expansion suppressor applying unit is a unit configured to apply and contact a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer.

The method for applying and contacting the volume expansion suppressor to the volume expansion layer is not particularly limited and may be appropriately selected depending on the intended purpose. An inkjet method is preferable. In other words, in the present disclosure, it is preferable to discharge the volume expansion suppressor by an inkjet method and apply the volume expansion suppressor to the volume expansion layer in the volume expansion suppressor applying step.

Application of the volume expansion suppressor to the volume expansion layer by inkjet discharging makes, for example, mold embossing unnecessary, and is more flexibly adaptable to various volume expansion patterns (volume expansion suppressing patterns). Therefore, production of a small number of printed matters (small-lot production) becomes available at a lower cost. Moreover, application of the volume expansion suppressor to the volume expansion layer by inkjet discharging makes it possible to apply the volume expansion suppressor more accurately and produce a printed matter having a more desirable bossed-recessed shape.

For example, the driving method of a discharging head used in the inkjet method may be a method employing, for example, PZT as a piezoelectric element actuator, a method of applying thermal energy, a method employing an on-demand head using an electrostatic force-applied actuator, and a method employing a continuous jet-type charge control-type head.

In the volume expansion layer forming step, the amount of the multifunctional monomer to be applied to a predetermined region of the volume expansion layer is increased in accordance with the degree of suppressing volume expansion of the predetermined region of the volume expansion layer.

As described above, in the present disclosure, it is possible to accurately control the degree (extent) of volume expansion of a predetermined region of the volume expansion layer by increasing the multifunctional monomer to be applied to the predetermined region in accordance with a desired degree (suppressing degree) of suppressing volume expansion of the predetermined region.

The degree of suppressing volume expansion of a predetermined region of the volume expansion layer can be identified from, for example, data indicating bosses and recesses of a printed matter to be produced. In the volume expansion suppressor applying step, for example, the volume expansion suppressor is applied and contacted to a portion corresponding to a recessed portion (a region to be suppressed from volume expansion) in the data indicating bosses and recesses of a printed matter to be produced, in a manner that the multifunctional monomer is applied in an amount corresponding to the recess size of the recessed portion (i.e., a height difference, or a thickness difference between a region not to be suppressed from volume expansion and the recessed portion). In this way, in the present disclosure, volume expansion of the volume expansion layer in the volume expanding step is suppressed to an arbitrary gradation, making it possible to form an arbitrary bossed-recessed shape and produce a printed matter having a desired bossed-recessed shape.

The degree of suppressing volume expansion of a predetermined region of the volume expansion layer may be a small value when the predetermined region is a region desired to be slightly suppressed from volume expansion (i.e., a region desired to be a small recess), and may be a large value when the predetermined region is a region not desired to have volume expansion (i.e., a region desired to be a large recess).

The method for increasing (controlling) the amount of the multifunctional monomer to be applied to a predetermined region of the volume expansion layer in accordance with the degree of suppressing volume expansion of the predetermined region of the volume expansion layer is not particularly limited and may be appropriately selected depending on the intended purpose.

Examples of the method for increasing the amount of the multifunctional monomer to be applied to a predetermined region of the volume expansion layer in accordance with the degree of suppressing volume expansion of the predetermined region of the volume expansion layer include, but are not limited to, a method of increasing the amount of the volume expansion suppressor to be applied and a method of increasing the concentration of the multifunctional monomer in the volume expansion suppressor to be applied.

The method for increasing (controlling) the amount of the volume expansion suppressor to be applied to a predetermined region of the volume expansion layer in accordance with the degree of suppressing volume expansion of the predetermined region of the volume expansion layer is not particularly limited and may be appropriately selected depending on the intended purpose.

In the present disclosure, in a preferable method for increasing the amount of the volume expansion suppressor to be applied to a predetermined region of the volume expansion layer, when discharging the volume expansion suppressor by an inkjet method to apply and contact the volume expansion suppressor to the volume expansion layer, the number of times to apply the volume expansion suppressor to the predetermined region of the volume expansion layer is controlled so that the amount of the multifunctional monomer to be applied to the predetermined region of the volume expansion layer may be controlled.

For example, when controlling the number of times to apply the volume expansion suppressor to a predetermined region of the volume expansion layer, the volume expansion suppressor is applied by a small number of times when the region to which the volume expansion suppressor is discharged is a region desired to be slightly suppressed from volume expansion (i.e., a region desired to be a small recess), whereas the volume expansion suppressor is applied by a large number of times when the region to which the volume expansion suppressor is discharged is a region not desired to have volume expansion (i.e., a region desired to be a large recess).

By controlling the number of times to apply the volume expansion suppressor to a predetermined region of the volume expansion layer in this way, it is possible to more accurately control the amount of the multifunctional monomer to be applied to the predetermined region of the volume expansion layer. Hence, it is possible to increase the amount of the multifunctional monomer to be applied to the predetermined region of the volume expansion layer with a more accurate control of the amount in accordance with the degree of suppressing volume expansion of the predetermined region.

The method for controlling the number of times to apply the volume expansion suppressor when applying the volume expansion suppressor to a predetermined region of the volume expansion layer by an inkjet method is not particularly limited and may be appropriately selected depending on the intended purpose.

A suitable method for controlling the number of times to apply the volume expansion suppressor is a method of controlling a discharging frequency at which the volume expansion suppressor is discharged by an inkjet method, or a method of controlling the pattern of discharging pulses by which the volume expansion suppressor is discharged by an inkjet method.

That is, in the present disclosure, it is preferable to control the number of times to apply the volume expansion suppressor, by controlling the discharging frequency at which the volume expansion suppressor is discharged by an inkjet method.

When controlling the discharging frequency at which the volume expansion suppressor is discharged by an inkjet method, for example, the discharging frequency is set to a small value when the region to which the volume expansion suppressor is discharged is a region desired to be slightly suppressed from volume expansion (i.e., a region desired to be a small recess), whereas the discharging frequency is set to a large value when the region to which the volume expansion suppressor is discharged is a region not desired to have volume expansion (i.e., a region desired to be a large recess).

There may be a limit to the discharging amount of the volume expansion suppressor dischargeable by an inkjet method. However, it is possible to increase the amount of the volume expansion suppressor dischargeable to the volume expansion layer by, for example, setting a high discharging frequency (or increasing the discharging frequency). Therefore, by controlling the discharging frequency at which the volume expansion suppressor is discharged by an inkjet method, it is possible to control the amount of the volume expansion suppressor dischargeable.

The discharging frequency (driving frequency) at which the volume expansion suppressor is discharged by an inkjet method is not particularly limited, may be appropriately selected depending on the intended purpose, and is preferably 1 kHz or higher but 100 kHz or lower and more preferably 15 kHz or higher but 30 kHz or lower.

In the present disclosure, it is also preferable to control the number of times to apply the volume expansion suppressor by controlling the pattern of discharging pulses by which the volume expansion suppressor is discharged by an inkjet method. Here, control on the pattern of discharging pulses means, for example, control on the pattern of voltage pulses applied to an inkjet head used when discharging the volume expansion suppressor by an inkjet method.

When controlling the pattern of discharging pulses, for example, small discharging pulses (low voltages) are set to adjust the amount of the volume expansion suppressor to a small amount when the region to which the volume expansion suppressor is discharged is a region desired to be slightly suppressed from volume expansion (i.e., a region desired to be a small recess whereas large discharging pulses (high voltages) are set to adjust the amount of the volume expansion suppressor to a large amount when the region to which the volume expansion suppressor is discharged is a region not desired to have volume expansion (i.e., a region desired to a large recess).

In this way, by controlling the pattern of discharging pulses by which the volume expansion suppressor is discharged by an inkjet method, it is possible to control the amount of the volume expansion suppressor to be applied and consequently to control the bossed-recessed shape of the printed matter.

As the method for increasing the amount of the volume expansion suppressor to be applied to a predetermined region of the volume expansion layer, it is also preferable to control the discharging amount of the volume expansion suppressor per liquid droplet, when increasing (controlling) the amount of the multifunctional monomer to be applied to the predetermined region of the volume expansion layer in accordance with the degree of suppressing volume expansion of the predetermined region of the volume expansion layer.

When controlling the discharging amount of the volume expansion suppressor per liquid droplet, for example, the discharging amount of the volume expansion suppressor per liquid droplet is set to a small amount when the region to which the volume expansion suppressor is discharged is a region desired to be slightly suppressed from volume expansion (i.e., a region desired to be a small recess), whereas the discharging amount of the volume expansion suppressor per liquid droplet is set to a large amount when the region to which the volume expansion suppressor is discharged is a region not desired to have volume expansion (i.e., a region desired to be a large recess).

In this way, by controlling the discharging amount of the volume expansion suppressor per liquid droplet, it is possible to more accurately control the amount of the multifunctional monomer to be applied to a predetermined region of the volume expansion layer, making it possible to increase the amount of the multifunctional monomer to be applied to the predetermined region of the volume expansion layer with a more accurate control of the amount in accordance with the degree of suppressing volume expansion of the predetermined region.

In the present disclosure, as described above, it is possible to produce a printed matter including a plurality of regions varied in the degree of volume expansion suppression (or the degree of volume expansion). In this case, in the present disclosure, for example, it is possible to produce a printed matter varied in the degree of volume expansion suppression and having a plurality of gradations (a plurality of level differences based on bosses and recesses), by varying the discharging amount, per liquid droplet, of the volume expansion suppressor to be discharged to each region, from region to region.

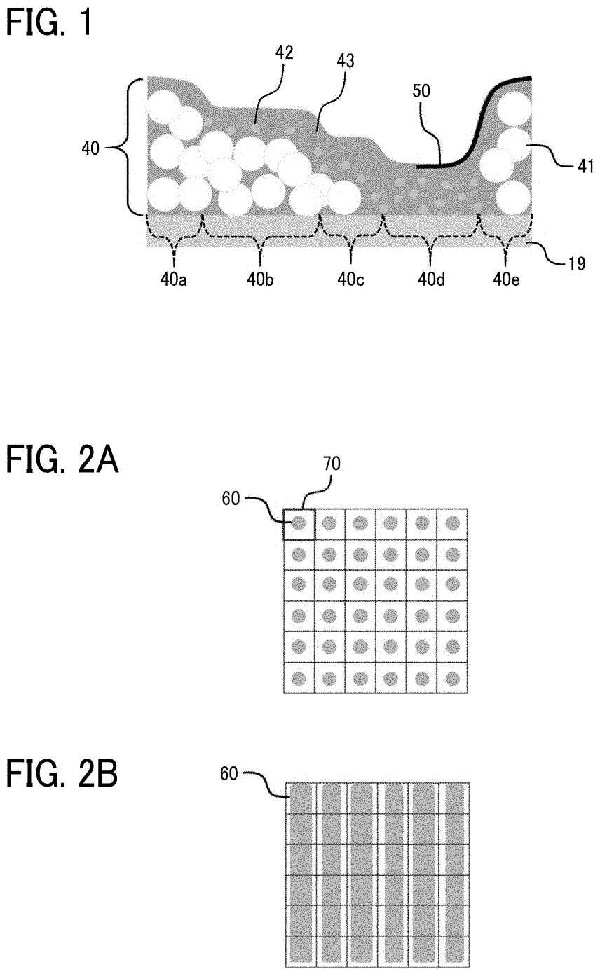

More specifically, the printed matter producing method of the present disclosure can produce a printed matter having a plurality of gradations (a plurality of level differences based on bosses and recesses) as illustrated in, for example, FIG. 1. That is, the printed matter producing method of the present disclosure can produce a printed matter having a plurality of gradations by contacting the multifunctional monomer (or the volume expansion suppressor) to be applied while increasing the amount of the multifunctional monomer (or, for example, the amount of the volume expansion suppressor) in accordance with the degree of volume expansion suppression (or the degree of volume expansion) of a plurality of regions of the volume expansion layer.

In FIG. 1, a volume expansion layer 40 is formed over a base material 19, and an image 50 is formed over a part of the volume expansion layer 40. Regions (40a, 40b, 40c, 40d, and 40e) varied in the degree of volume expansion suppression (or the degree of volume expansion) are formed in the volume expansion layer 40, and the ratio between the volume expansion agent 41 that has been volume-expanded (foamed) and the volume expansion agent 42 that has been suppressed from volume expansion is varied from region to region. In the volume expansion layer 40, the volume expansion agent 41 that has been volume-expanded and the volume expansion agent 42 that has been suppressed from volume expansion are dispersed in a volume expansion layer forming liquid 43.

In the present disclosure, when controlling the discharging amount of the volume expansion suppressor per liquid droplet, for example, it is also possible to vary the discharging amount, per liquid droplet, of the volume expansion suppressor to be discharged to a predetermined region of the volume expansion layer, within the predetermined region. That is, in the present disclosure, it is possible to vary the discharging amount of the volume expansion suppressor per liquid droplet, within a region equal in the degree of volume expansion suppression.

Here, as regards a case of forming a medium gradation (for example, the region 40c in FIG. 1) in a printed matter, an embodiment of applying the volume expansion suppressor in a uniform (constant) amount over the entire surface of the region that is to have the medium gradation, with adjustment of the discharging amount (liquid droplet amount) of the volume expansion suppressor in a manner to enable formation of the medium gradation (medium level) will be described.

FIG. 2A is a diagram illustrating an example of the discharging amount of the volume expansion suppressor to be discharged per unit area when discharging the volume expansion suppressor in a uniform discharging amount per liquid droplet to the region that is to have the medium gradation. As illustrated in FIG. 2A, in the present disclosure, for example, the medium gradation may be formed by discharging of a liquid droplet of the volume expansion suppressor 60 to the entire surface of the region that is to have the medium gradation, in a uniform discharging amount per unit area 70.

However, in such an embodiment as illustrated in FIG. 2A, a linear “streak” of the volume expansion suppressor 60 might occur in the direction in which the base material is conveyed when the volume expansion suppressor 60 is applied by line head method discharging or in the direction in which the discharging head is scanned when the volume expansion suppressor 60 is applied by serial head method discharging. When it is assumed that the direction in which the base material is conveyed or the direction in which the discharging head is scanned in FIG. 2A is the top down direction (vertical direction) of FIG. 2A, the volume expansion suppressor 60 might be distributed in a streak shape in the vertical direction as illustrated in FIG. 2B when the volume expansion suppressor 60 is spread over the volume expansion layer, so the surface shape of the region that is to have the medium gradation in the volume expansion layer might be a streak shape.

The cause of the streak-shaped distribution of the volume expansion suppressor 60 in the vertical direction as illustrated in FIG. 2B is, for example, fast spreading (diffusion) of the landed volume expansion suppressor 60 over the volume expansion layer within a time lag in landing of the volume expansion suppressor 60 on the volume expansion layer due to the offset between the nozzle lines of the discharging head (inkjet head) used for discharging the volume expansion suppressor 60. That is, because the next liquid droplet of the volume expansion suppressor 60 lands after a landed liquid droplet of the volume expansion suppressor 60 has spread over the volume expansion layer, a streak of the volume expansion suppressor 60 might be generated in the direction in which the base material is conveyed or in the direction in which the discharging head is scanned.

Hence, in the present disclosure, it is preferable to vary the discharging amount of the volume expansion suppressor to be discharged to a predetermined region of the volume expansion layer within the predetermined region, in a manner to enable suppressing generation of a “streak” of the surface shape of the region that is to have the volume expansion suppressor and the medium gradation. In other words, in the present disclosure, it is preferable to vary the discharging amount of the volume expansion suppressor, within the region equal in the degree of volume expansion suppression, in a manner to enable suppressing generation of a “streak” of the surface shape of the region that is to have the volume expansion suppressor and the medium gradation.

The method for varying the discharging amount of the volume expansion suppressor in a manner to enable suppressing generation of a “streak” is not particularly limited and may be appropriately selected depending on the intended purpose, and it is preferable to vary the discharging amount between unit areas adjacent to each other. In other words, in the present disclosure, when applying the volume expansion suppressor to a predetermined region of the volume expansion layer by discharging the volume expansion suppressor per unit area of the predetermined region, it is preferable to vary the discharging amount of the volume expansion suppressor per unit area between unit areas adjacent to each other.

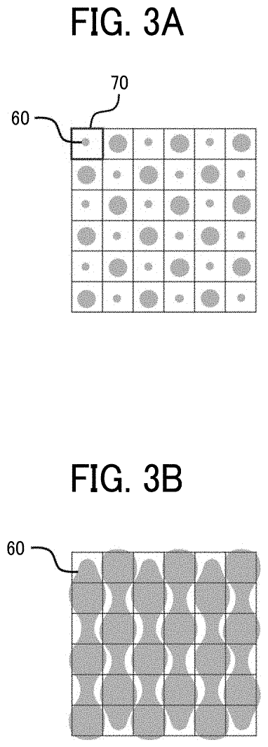

FIG. 3A is a diagram illustrating an example of a discharging amount of the volume expansion suppressor per unit area when making the discharging amount of the volume expansion suppressor to be discharged to a region that is to have the medium gradation nonuniform in order to vary the discharging amount of the volume expansion suppressor to be discharged to unit areas adjacent to each other. As illustrated in FIG. 3A, in the present disclosure, it is preferable to make the discharging amount of the volume expansion suppressor for adjacent unit areas 70 nonuniform by varying the discharging amount (liquid droplet amount) of the volume expansion suppressor 60 between the unit areas 70 adjacent to each other in the region that is to have the medium gradation.

As illustrated in FIG. 3A, by varying the discharging amount of the volume expansion suppressor 60 per unit area 70 between unit areas 70 adjacent to each other, it is possible to suppress generation of a linear “streak” of the surface shape of the region that is to have the volume expansion suppressor 60 and the medium gradation when the volume expansion suppressor 60 spreads over the volume expansion layer as illustrated in FIG. 3B.

In the present disclosure, as illustrated in FIG. 3A, it is preferable to vary the discharging amount of the volume expansion suppressor 60 per unit area 70 between unit areas 70 adjacent to each other over the entire surface of a predetermined region (for example, the region that is to have the medium gradation) of the volume expansion layer. In the present disclosure, for example, it is possible to vary the discharging amount of the volume expansion suppressor 60 per unit area 70 among three or more continuous unit areas 70 so that these unit areas 70 have different three or more levels of discharging amounts.

Here, when varying the discharging amount of the volume expansion suppressor per unit area between unit areas adjacent to each other, the discharging amount of the volume expansion suppressor to be discharged to each unit area is not particularly limited and may be appropriately selected depending on the intended purpose so long as the discharging amount is varied between unit areas adjacent to each other.

As regards the discharging amount of the volume expansion suppressor per unit area when varying the discharging amount of the volume expansion suppressor per unit area between unit areas adjacent to each other, it is preferable that the discharging amount of the volume expansion suppressor to be discharged to one of two unit areas adjacent to each other in a predetermined region of the volume expansion layer be 0.5X or less, where the total discharging amount of the volume expansion suppressor to be discharged to the two unit areas adjacent to each other is 2X. In other words, in the present disclosure, when the total discharging amount of the volume expansion suppressor to be discharged to the two unit areas adjacent to each other in a predetermined region of the volume expansion layer is 2X, it is preferable to control the discharging amount of the volume expansion suppressor in a manner that the discharging amount of the volume expansion suppressor to be discharged to one of the two unit areas adjacent to each other is 0.5X or less.

Here, when the total discharging amount of the volume expansion suppressor to be discharged to two unit areas adjacent to each other is 2X, and the discharging amount of the volume expansion suppressor to be discharged to one (first unit area) of the two unit areas adjacent to each other is 0.5X or less (i.e., less than or equal to 50% of X), the discharging amount of the volume expansion suppressor to be discharged to the other (second unit area) of the two unit areas adjacent to each other is 1.5X or greater (i.e., greater than or equal to 150% of X). That is, in the present disclosure, it is preferable that the discharging amount of the volume expansion suppressor to be discharged to one (first unit area) of two unit areas adjacent to each other be 0.5X or less, and that the discharging amount of the volume expansion suppressor to be discharged to the other unit area (second unit area) adjacent to the one unit area be 1.5X or greater.

In the present disclosure, this makes it possible to make the difference in the discharging amount (liquid droplet amount) between unit areas adjacent to each other even greater, and make the discharging pattern of the volume expansion suppressor in a predetermined region more nonuniform. Hence, it is possible to better suppress generation of a linear “streak” of the surface shape of the region that is to have the volume expansion suppressor and the medium gradation.

A unit area in a predetermined region of the volume expansion layer may be, for example, an area that includes in a boundary thereof, a middle position (medium position) between a predetermined position to which the volume expansion suppressor is discharged (e.g., the predetermined position being the center of a liquid droplet landed) and a position to which the volume expansion suppressor is discharged next to the predetermined position and that centers on the position of each droplet of the volume expansion suppressor. When discharging a plurality of liquid droplets of the volume expansion suppressor simultaneously, a unit area in a predetermined region of the volume expansion layer may be an area that includes in a boundary thereof, a middle position (medium position) between positions to which the liquid droplets of the volume expansion suppressor land adjacently to each other and that centers on the position to which each droplet of the volume expansion suppressor lands.

In the present disclosure, as described above, it is also preferable to increase the concentration of the multifunctional monomer in the volume expansion suppressor to be applied, when increasing (controlling) the amount of the multifunctional monomer to be applied to a predetermined region of the volume expansion layer in accordance with the degree of suppressing volume expansion of the predetermined region of the volume expansion layer.

That is, in the present disclosure, in the volume expansion suppressor applying step, it is preferable to control the amount of the multifunctional monomer to be applied to a predetermined region of the volume expansion layer by selecting and applying any of a plurality of volume expansion suppressors having different multifunctional monomer concentrations in accordance with the degree of suppressing volume expansion of the predetermined region of the volume expansion layer.

When applying any of a plurality of volume expansion suppressors having different multifunctional monomer concentrations, for example, a volume expansion suppressor having a low multifunctional monomer concentration is applied when the region to which the volume expansion suppressor is discharged is a region desired to be slightly suppressed from volume expansion (i.e., a region desired to be a small recess), whereas a volume expansion suppressor having a high multifunctional monomer concentration is applied when the region to which the volume expansion suppressor is discharged is a region not desired to have volume expansion (i.e., a region desired to be a large recess),

### <<Volume Expansion Suppressor>>

The volume expansion suppressor contains a multifunctional monomer and further contains other components as needed.

### —Multifunctional Monomer—

As the multifunctional monomer, the same multifunctional monomer as used in the volume expansion layer forming liquid can be used. Examples of the multifunctional monomer include, but are not limited to, 1,6-hexanediol di(meth)acrylate, 1,6-hexanediol diacrylate, 1,3-butylene glycol diacrylate, 1,4-butanediol diacrylate, diethylene glycol diacrylate, neopentyl glycol diacrylate, and dipropylene glycol diacrylate. Moreover, mixtures of different multifunctional monomers, mixtures of multifunctional monomers with monofunctional monomers, mixtures of multifunctional oligomers with monofunctional monomers, and mixtures of monofunctional monomers, multifunctional monomers, and multifunctional oligomers may also be used.

### —Other Components—

The other components of the volume expansion suppressor are not particularly limited and may be appropriately selected depending on the intended purpose. For example, the same components as the other components in the volume expansion layer forming liquid may be used. For example, it is preferable to use a polymerization initiator.

The viscosity of the volume expansion suppressor is not particularly limited, may be appropriately selected depending on the intended purpose, and is preferably 1 mPa·s or higher but 100 mPa·s or lower at 25 degrees C.

The viscosity of the volume expansion suppressor can be measured with, for example, a rheometer MCR301 available from Anton Paar GmbH and a cone plate CP25-1 at a shear rate of 10/s at 25 degrees C.

The static surface tension of the volume expansion suppressor is not particularly limited, may be appropriately selected depending on the intended purpose, and is preferably 20 mN/m or higher but 55 mN/m or lower at 25 degrees C. In the following description, the static surface tension of the volume expansion suppressor at 25 degrees C. may be referred to as “static surface tension B”.

The static surface tension of the volume expansion suppressor can be measured with, for example, an automatic surface tensiometer DY-300 available from Kyowa Interface Science, Inc. according to a plate method or a ring method.

In the present disclosure, it is preferable that the static surface tension A of the volume expansion layer forming liquid described above and the static surface tension B of the volume expansion suppressor be close values. More specifically, it is preferable that the static surface tension A of the volume expansion layer forming liquid at 25 degrees C. and the static surface tension B of the volume expansion suppressor at 25 degrees C. satisfy the following inequality [|A−B|≤6 mN/m].

With the static surface tension A of the volume expansion layer forming liquid at 25 degrees C. and the static surface tension B of the volume expansion suppressor at 25 degrees C. satisfying the inequality described above, the static surface tension A and the static surface tension B become close values. This improves permeability of the volume expansion suppressor into the volume expansion layer. When the volume expansion suppressor has an improved permeability into the volume expansion layer, it can more effectively suppress volume expansion of the volume expansion layer in a region to which it is applied, making it possible to produce a printed matter having a better bossed-recessed shape.

In the inequality, |A−B| means the absolute value of the difference between the static surface tension A and the static surface tension B.

The application amount of the volume expansion suppressor is not particularly limited, may be appropriately selected depending on the intended purpose, and is preferably 0.01 microliters/cm² or greater but 8 microliters/cm² or less with respect to the surface of the volume expansion layer. That is, in the present disclosure, the amount of the volume expansion suppressor to be applied to a predetermined region of the volume expansion layer in the volume expansion suppressor applying step is preferably 0.01 microliters/cm² or greater but 8 microliters/cm² or less with respect to the surface of the volume expansion layer.

In this case, wide-range control of the amount of permeation into the volume expansion layer is available in accordance with the application amount of the volume expansion suppressor, making it possible to control the bossing or recessing amount (height difference) of a printed matter in a wide range (width).

The discharging speed of the volume expansion suppressor is not particularly limited, may be appropriately selected depending on the intended purpose, and is preferably 5 m/s or higher and more preferably 5 m/s or higher but 15 m/s or lower. In this case, the volume expansion suppressor can be discharged more stably.

The dot density (image resolution) of the liquid droplets of the volume expansion suppressor to be discharged is preferably 240 dpi×240 dpi (dot per inch) or greater.

### <Volume Expanding Step and Volume Expanding Unit>

The volume expanding step is a step of heating the volume expansion layer after the volume expansion suppressor applying step to volume-expand (foam) the volume expansion layer.

The volume expanding unit is a unit configured to heat the volume expansion layer after the volume expansion suppressor applying unit applies the volume expansion suppressor to volume-expand (foam) the volume expansion layer.

The volume expanding unit is not particularly limited and may be appropriately selected depending on the intended purpose so long as the volume expanding unit is a unit that can volume-expand (foam) the volume expansion agent in the volume expansion layer by heating. Examples of the volume expanding unit include, but are not limited to, infrared beaters, hot air heaters, and heating rollers.

The heating temperature in the volume expanding step is not particularly limited and may be appropriately selected depending on the intended purpose so long as it is higher than or equal to the thermal decomposition temperature of the volume expansion agent, and is preferably, for example, 100 degrees C. or higher but 200 degrees C. or lower.

The timing at which the volume expanding step is performed is not particularly limited and may be appropriately selected depending on the intended purpose so long as the timing is after the volume expansion suppressor applying step is performed. More specifically, for example, as described above, after the volume expansion suppressor applying step, the volume expanding step may be performed collectively when the volume expansion layer forming liquid is cured by application of thermal energy, or the volume expanding step may be performed after the volume expansion layer forming liquid is cured.

### <Image Forming Step and Image Forming Unit>

In the present disclosure, an image may be formed on a printed matter. More specifically, the printed matter producing method of the present disclosure may include an image forming step described below, and the printed matter producing apparatus of the present disclosure may include an image forming unit described below.

The image forming step is a step of applying an ink containing a colorant over the volume expansion layer to form an image.

The image forming unit is a unit configured to apply an ink containing a colorant over the volume expansion layer to form an image.

The image forming unit is not particularly limited and may be appropriately selected depending on the intended purpose. Examples of the image forming unit include, but are not limited to, combination of a known material applying unit (e.g., a coating unit and a discharging unit) and a known energy applying unit (e.g., a thermal energy applying unit and an active energy ray irradiation unit), like the foamable layer forming unit.

The image forming step is not particularly limited so long as an image can be formed. For example, it is preferable that the material applying unit apply an ink containing a colorant over the volume expansion layer, and then the energy applying unit cure the ink to form an image.

The timing at which the ink is cured is not particularly limited and may be appropriately selected depending on the intended purpose. For example, when curing the volume expansion layer, the volume expansion layer and the ink that forms an image may be cured collectively.

The method for applying the ink over the volume expansion layer is not particularly limited and may be appropriately selected depending on the intended purpose. An inkjet method is preferable in terms of productivity and flexible adaptability to multiple items in small lots.

For example, the driving method of a discharging head used in the inkjet method may be a method employing, for example, PZT (lead titanate zirconate) as a piezoelectric element actuator, a method of applying thermal energy, a method employing an on-demand head using an electrostatic force-applied actuator, and a method employing a continuous jet-type charge control-type head.

Three, four, or more kinds of inks may be applied in the image forming step depending on the colorants (pigments) contained in the inks. For example, these inks are applied by different inkjet heads. Alternatively, one head including a plurality of nozzle lines may be used to discharge different inks from different nozzle lines. It is preferable to change the head nozzle density at which each ink is discharged, depending on the image resolution of the image to be formed in the image forming step and the number of times to scan the head. For example, the head nozzle density may be 240 npi (nozzle per inch), 300 npi, 600 npi, and 1,200 npi.

The application amount of the ink is not particularly limited, may be appropriately selected depending on the intended purpose, and is preferably 3 microliters/cm² or less with reference to the surface of the volume expansion layer.

The discharging speed of the ink is not particularly limited, may be appropriately selected depending on the intended purpose, and is preferably 5 n/s or higher and more preferably 5 m/s or higher but 15 m/s or lower. In this case, the ink can be discharged more stably.

The dot density (image resolution) of the liquid droplets of the ink to be discharged is preferably 240 dpi×240 dpi (dot per inch) or higher.

The shape of the image is not particularly limited and may be appropriately selected depending on the intended purpose. For example, using an inkjet head, inks may be discharged based on data of the image on the printed matter to be produced, to form an arbitrary image (colorant layer).

### <<Ink>>

The ink contains a colorant, preferably contains a polymerizable compound and a polymerization initiator, and further contains other components as needed.

### —Colorant—

As the colorant, various pigments and dyes may be used that impart black, white, magenta, cyan, yellow, green, orange, purple, and gloss colors such as gold and silver, depending on the intended purpose of the ink of the present and requisite properties thereof.

A content of the colorant is not particularly limited, may be appropriately determined considering, for example, a desired color density and dispersibility in the composition, and is preferably from 0.1% by mass to 20% by mass and more preferably from 1% by mass to 10% by mass relative to the total mass (100% by mass) of the ink.

The colorant can be either inorganic or organic, and two or more of the colorants can be used in combination.

Specific examples of the inorganic pigments include, but are not limited to, carbon blacks (C.I. Pigment Black 7) such as furnace black, lamp black, acetylene black, and channel black, iron oxides, and titanium oxides.

Specific examples of the organic pigments include, but are not limited to, azo pigments such as insoluble azo pigments, condensed azo pigments, azo lakes, and chelate azo pigments, polycyclic pigments such as phthalocyanine pigments, perylene and perinone pigments, anthraquinone pigments, quinacridone pigments, dioxazine pigments, thioindigo pigments, isoindolinone pigments, and quinophthalone pigments, dye chelates (e.g., basic dye chelates, acid dye chelates), dye lakes (e.g., basic dye lakes, acid dye lakes), nitro pigments, nitroso pigments, aniline black, and daylight fluorescent pigments.

The ink may further contain a dispersant in order to improve dispersibility of the pigment.

The dispersant is not particularly limited. Examples of the dispersant include, but are not limited to, dispersants commonly used to prepare pigment dispersions, such as polymeric dispersants.

The dyes are not particularly limited. Specific examples of the dyes include, but are not limited to acidic dyes, direct dyes, reactive dyes, and basic dyes. One of these dyes may be used alone or two or more of these dyes may be used in combination.

### —Polymerizable Compound—

The polymerizable compound may be the same as the polymerizable solvent (polymerizable compound) of the volume expansion layer forming liquid of the volume expansion layer described above.

The content of the polymerizable compound in the ink is not particularly limited, may be appropriately selected depending on the intended purpose, and is preferably 70% by mass or greater but 95% by mass or less relative to the total amount of the ink.

### —Polymerization Initiator—

The polymerization initiator may be the same as the polymerization initiator of the volume expansion layer forming liquid of the volume expansion layer described above.

The ink may further contain a dispersant in order to improve dispersibility of the pigment. The dispersant is not particularly limited. Examples of the dispersant include, but are not limited to, dispersants commonly used to prepare pigment dispersions, such as polymeric dispersants.

### —Other Components—

The other components of the ink are not particularly limited and may be appropriately selected depending on the intended purpose. Examples of the other components include, but are not limited to, an organic solvent, a surfactant, a polymerization inhibitor, a leveling agent, a defoaming agent, a fluorescent brightener, a permeation enhancing agent, a wetting agent (humectant), a fixing agent, a viscosity stabilizer, a fungicide, a preservative, an antioxidant, an ultraviolet absorbent, a chelate agent, a pH adjuster, and a thickener.

The method for curing the ink when curing the ink is not particularly limited and may be appropriately selected depending on the intended purpose. For example, the ink can be cured by application of energy, like the volume expansion layer.

### <Other Steps and Other Units>

The other steps are not particularly limited and may be appropriately selected depending on the intended purpose. Examples of the other steps include, but are not limited to, a protective layer forming step of forming a protective layer, an embossing step, a bending step, a cutting step, and a controlling step.

The other units are not particularly limited and may be appropriately selected depending on the intended purpose. Examples of the other units include, but are not limited to, a protective layer forming unit configured to form a protective layer, an embossing unit, a bending unit, a cutting unit, and a controlling unit.

The printed matter producing apparatus of the present disclosure used in the printed matter producing method of the present disclosure will be described in detail with reference to the drawings.

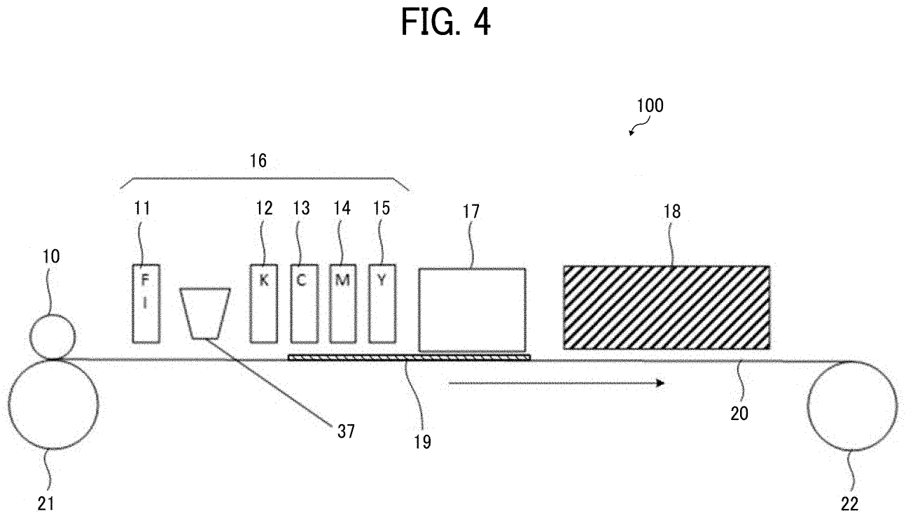

FIG. 4 is a schematic view illustrating an example of the printed matter producing apparatus of the present disclosure. The printed matter producing apparatus 100 of FIG. 4 includes a coating roller 10 configured to apply the volume expansion layer forming liquid over a base material 19. At the downstream of the coating roller 10, the printed matter producing apparatus 100 includes a discharging head 16 including a head 11 for the volume expansion suppressor, a head 12 for black, a head 13 for cyan, a head 14 for magenta, and a head 15 for yellow, active energy ray irradiators 17 and 37, and a heating device 18. In FIG. 4, the reference numeral 20 denotes a conveyor belt, the reference numeral 21 denotes a sending roller counter to the coating roller 10, and the reference numeral 22 denotes a winding roller.

The base material 19 is conveyed in the direction of the arrow in FIG. 4 with the conveyor belt 20 wound up by the winding roller 22.

First, the coating roller 10 applies the volume expansion layer forming liquid over the surface of the base material 19.

Next, with the base material 19 scanned at a predetermined speed, the head 11 for the volume expansion suppressor discharges the volume expansion suppressor containing a multifunctional monomer to a predetermined region of the volume expansion layer, to apply and contact the volume expansion suppressor to the layer formed of the volume expansion layer forming liquid.

Here, the head 11 for the volume expansion suppressor applies and contacts the volume expansion suppressor to the layer formed of the volume expansion layer forming liquid while increasing the amount of the multifunctional monomer to be applied to the predetermined region of the volume expansion layer in accordance with the degree of suppressing volume expansion of the predetermined region identified based on, for example, data indicating bosses and recesses of a printed matter to be produced. That is, in this example, the head 11 for the volume expansion suppressor is an example of the volume expansion suppressor applying unit.

Next, the active energy ray irradiator 37 irradiates the base material 19 coated with the volume expansion layer forming liquid to which the volume expansion suppressor is applied with active energy rays under predetermined irradiation conditions, to cure the volume expansion layer forming liquid and form a volume expansion layer. That is, in this example, the coating roller 10 and the active energy ray irradiator 37 are an example of the volume expansion layer forming unit.

Next, the heads for colors, namely the head 12 for black, the head 13 for cyan, the head 14 for magenta, and the head 15 for yellow discharge black, cyan, magenta, and yellow inks by an inkjet method. Then, the active energy ray irradiator 17 irradiates the base material 19 coated with the inks with active energy rays under predetermined irradiation conditions, to cure the inks and form an image. That is, in this example, the discharging head 16 and the active energy ray irradiator 17 are an example of the image forming unit.

Next, the heating device 18 heats the volume expansion layer to volume-expand (foam) the volume expansion layer. That is, in this example, the heating device 18 is an example of the volume expanding unit.

In this way, the printed matter produced by the printed matter producing apparatus 100 has a desired bossed-recessed shape.

FIG. 4 illustrates a printed matter producing apparatus 100 of a single-pass type that has an inkjet head-printable width greater than the width of the printing target base material to perform scanning once. The printed matter producing apparatus of the present disclosure may be of a multi-pass type having a head width smaller than the width of the base material and provided with a driving mechanism (head unit or base material conveying) that enable scanning more than once.

### EXAMPLES

The present disclosure will be described below by way of Examples. The present disclosure should not construed as being limited to these Examples.

### <Preparation of Volume Expansion Layer Forming Liquid 1>

KUREHA MICROSPHERE (obtained from KUREHA Corporation, H750) serving as a volume expansion agent (15 parts by mass), methoxypolyethylene glycol #400 acrylate (obtained from Shin-Nakamura Chemical Co., Ltd., AM-90G) serving as a polymerizable solvent (polymerizable compound)(50 parts by mass), 2-acryloyloxypropyl phthalic acid (obtained from Shin-Nakamura Chemical Co., Ltd., ACB-21) (50 parts by mass), and OMNIRAD TPO (obtained from IGM Resins B.V.) serving as a polymerization initiator (5 parts by mass) were stirred, to prepare a volume expansion layer forming liquid 1.

The static surface tension of the volume expansion layer forming liquid 1 at 25 degrees C. measured with an automatic surface tensiometer DY-300 (obtained from Kyowa Interface Science, Inc.) according to a platinum plate method was 34.6 mN/m. The viscosity of the volume expansion layer forming liquid 1 at 25 degrees C. measured with a rheometer MCR301 (obtained from Anton Paar GmbH) at a shear rate of 10/s was 250 mPa·s.

### <Preparation of Volume Expansion Suppressor 1>

1,6-Hexanediol diacrylate (SR238, obtained from Arkema S.A.) serving as a multifunctional monomer (100 parts by mass) and OMNIRAD TPO (obtained from IGM Resins B.V) (5 parts by mass) serving as a polymerization initiator were stirred, to prepare a volume expansion suppressor 1.

The static surface tension of the volume expansion suppressor 1 at 25 degrees C. measured by the same method for measuring the volume expansion layer forming liquid 1 was 35.7 mN/m.

Next, using the printed matter producing apparatus 100 illustrated in FIG. 4, and the volume expansion layer forming liquid 1 and the volume expansion suppressor 1 prepared, a printed matter 1 was obtained in the manner described below.

As the head 11 for the volume expansion suppressor, MH5420 (600 dpi) obtained from Ricoh Company, Ltd. was used, In this example, inks were not discharged from the heads for colors, namely the head 12 for black, the head 13 for cyan, the head 14 for magenta, and the head 15 for yellow, to produce a printed matter 1 formed of a base material and a volume expansion layer.

As the active energy ray irradiators 17 and 37, EC300/30/30 mA obtained from Iwasaki Electric Co., Ltd. was used. As an inert gas source, a N₂ gas generator equipped with a compressor (MAXI-FLOW 30, obtained from Inhouse Gas AG) was coupled to within an inert gas bracket at a pressure of 0.2 MPa·s, to flow N₂ at a flow rate of from 2 L/minute through 10 L/minute to set the oxygen concentration to 500 ppm or lower.

As the heating device 18, a heating device produced by combining LATEX BLOWER G SERIES obtained from Hitachi Industrial Equipment Systems Co., Ltd., a high hot air-generating electric heater XS-2 obtained from K.K. Kansai Dennetsu, and a high-blow nozzle 50AL obtained from K.K. Kansai Dennetsu and adjusting a wind speed from the nozzle tip to 30 m/sec was used.

In Example 1, first, the coating roller 10 applied the prepared volume expansion layer forming liquid 1 with an average thickness of 100 micrometers over the surface of the base material 19, which was paper (high-grade plain paper RJPH-03, obtained from Ostrichdia Co., Ltd.) having a mass (basis weight) of 80 g/m² per unit area.

Next, with the base material 19, over which a layer of the volume expansion layer forming liquid 1 was formed, scanned at a speed of 15 m/min, the head 11 for the volume expansion suppressor discharged the volume expansion suppressor 1 described below under the conditions described below.

### Conditions for Discharging Volume Expansion Suppressor 1 in Example 1

Pattern: 10 dotline (a line having a width of 423 micrometers)
Discharging amount per liquid droplet: 8.5 pL/nozzle
Discharging amount per unit area: 0.47 microliters/cm²
Discharging frequency: 1.2 kHz
Discharging speed: 7 m/sec

Next, the active energy ray irradiator 37 irradiated the volume expansion layer forming liquid 1 with active energy rays under irradiation conditions of 30 kV as an accelerating voltage and 30 kGy as a dose, to cure the volume expansion layer forming liquid 1 and form a volume expansion layer.

Next, the heating device 18 heated the base material 19 over which the volume expansion layer was formed at 170 degrees C. for 10 seconds, to volume-expand the volume expansion layer. In this way, a printed matter 1 of Example 1 was obtained.

### <Measurement of Thickness of Volume Expansion Layer>

The thickness profile of the volume expansion layer of the printed matter 1 was measured with a laser microscope VK-X100 obtained from Keyence Corporation.

Next, the average thicknesses of the regions to which the volume expansion suppressor was applied and the regions to which the volume expansion suppressor was not applied in the volume expansion layer of the printed matter 1 were measured respectively. The average thickness of the volume expansion layer was obtained by scraping the volume expansion layer at different ten positions of the regions of which average thickness was to be measured, measuring the height of the scraped portions from the base material to the surface of the volume expansion layer with a laser microscope VK-X100 obtained from Keyence Corporation, and calculating the average of the measured heights. As for the regions to which the volume expansion suppressor was applied, the thickness at about the center of the regions (i.e., near the most recessed position of the recesses) was measured.

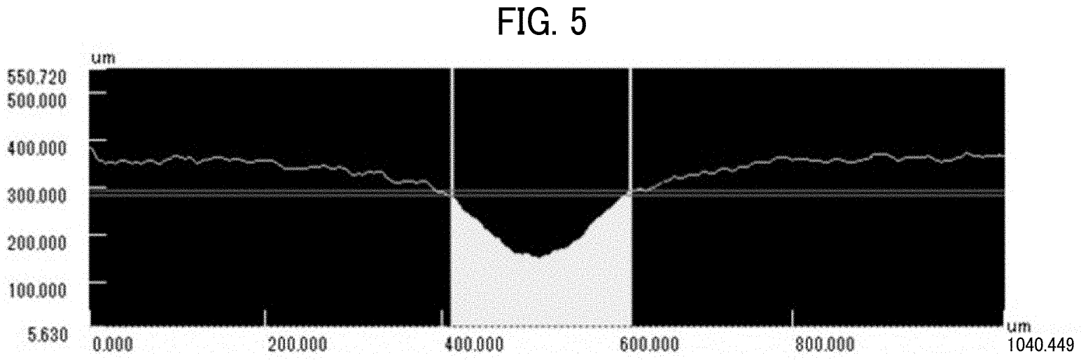

FIG. 5 is a graph plotting an example of the thickness profile of a region to which the volume expansion suppressor was applied and regions to which the volume expansion suppressor was not applied in the volume expansion layer of the printed matter 1 produced in Example 1. In FIG. 5, the vertical axis represents the thickness (unit: micrometer) of the volume expansion layer, and the horizontal axis represents the position in the volume expansion layer in the horizontal direction (unit: micrometer). The profile plotted in FIG. 5 is a thickness profile in a cross section including the center portion of the region to which the volume expansion suppressor was applied (i.e., near the most recessed position of the recess).

As plotted in FIG. 5, it can be seen that a recess was formed in the printed matter 1 produced in Example 1 in a region near the center of the profile.

The average thickness of the regions to which the volume expansion suppressor was applied in the volume expansion layer of the printed matter t was 217 micrometers, and the average thickness of the regions to which the volume expansion suppressor was not applied in the volume expansion layer of the printed matter 1 was 423 micrometers. Hence, in Example 1, volume expansion of the regions to which the volume expansion suppressor was applied was suppressed by 206 micrometers on the average compared with the regions to which the volume expansion suppressor was not applied, and a printed matter having a height difference of 206 micrometers was produced.

### Example 2

A printed matter 2 was produced in the same manner as in Example 1, except that unlike in Example 1, the discharging amount per liquid droplet was changed to 14 pL/nozzle and the discharging amount per unit area was changed to 0.78 microliters/m².

A thickness profile of the volume expansion layer of the printed matter 2 was obtained in the same manner as in Example 1, and the average thicknesses of the regions to which the volume expansion suppressor was applied and the regions to which the volume expansion suppressor was not applied in the volume expansion layer were measured respectively.

The average thickness of the regions to which the volume expansion suppressor was applied in the volume expansion layer of the printed matter 2 was 252 micrometers, and the average thickness of the regions to which the volume expansion suppressor was not applied in the volume expansion layer of the printed matter 2 was 411 micrometers. Hence, in Example 2, volume expansion of the regions to which the volume expansion suppressor was applied was suppressed by 159 micrometers on the average compared with the regions to which the volume expansion suppressor was not applied, and a printed matter having a height difference of 159 micrometers was produced.

### Example 3

A printed matter 3 was produced in the same manner as in Example 1, except that unlike in Example 1, the discharging amount per liquid droplet was changed to 28 pL/nozzle and the discharging amount per unit area was changed to 1.56 microliters/cm².

A thickness profile of the volume expansion layer of the printed matter 3 was obtained in the same manner as in Example 1, and the average thicknesses of the regions to which the volume expansion suppressor was applied and the regions to which the volume expansion suppressor was not applied in the volume expansion layer were measured respectively.

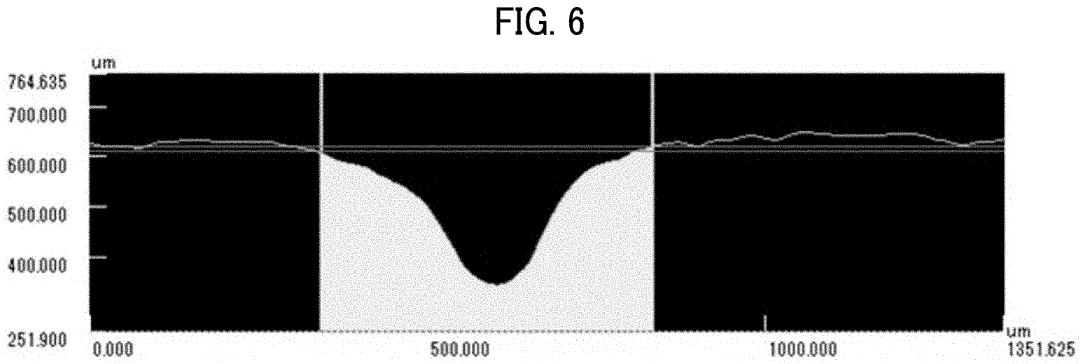

FIG. 6 is a graph plotting an example of the thickness profile of a region to which the volume expansion suppressor was applied and regions to which the volume expansion suppressor was not applied in the volume expansion layer of the printed matter 3 produced in Example 3. In FIG. 6, the vertical axis represents the thickness (unit: micrometer) of the volume expansion layer, and the horizontal axis represents the position in the volume expansion layer in the horizontal direction (unit: micrometer). The profile plotted in FIG. 6 is a thickness profile in a cross section including the center portion of the region to which the volume expansion suppressor was applied (i.e., near the most recessed position of the recess).

As plotted in FIG. 6, it can be seen that a recess having a different shape from Examples 1 and 2 was formed in the printed matter 3 produced in Example 3 in a region near the center of the profile.

The average thickness of the regions to which the volume expansion suppressor was applied in the volume expansion layer of the printed matter 3 was 102 micrometers, and the average thickness of the regions to which the volume expansion suppressor was not applied in the volume expansion layer of the printed matter 3 was 402 micrometers. Hence, in Example 3, volume expansion of the regions to which the volume expansion suppressor was applied was suppressed by 300 micrometers on the average compared with the regions to which the volume expansion suppressor was not applied, and a printed matter having a height difference of 300 micrometers was produced.

### Example 4

A printed matter 4 was produced in the same manner as in Example 1, except that unlike in Example 1, MH2420 (300 dpi) obtained from Ricoh Company, Ltd. was used as the head 11 for the volume expansion suppressor, the pattern was changed to 8 dotline, the discharging amount per liquid droplet was changed to 40 pL/nozzle, and the discharging amount per unit area was changed to 2.23 microliters/cm².

A thickness profile of the volume expansion layer of the printed matter 4 was obtained in the same manner as in Example 1, and the average thicknesses of the regions to which the volume expansion suppressor was applied and the regions to which the volume expansion suppressor was not applied in the volume expansion layer were measured respectively.

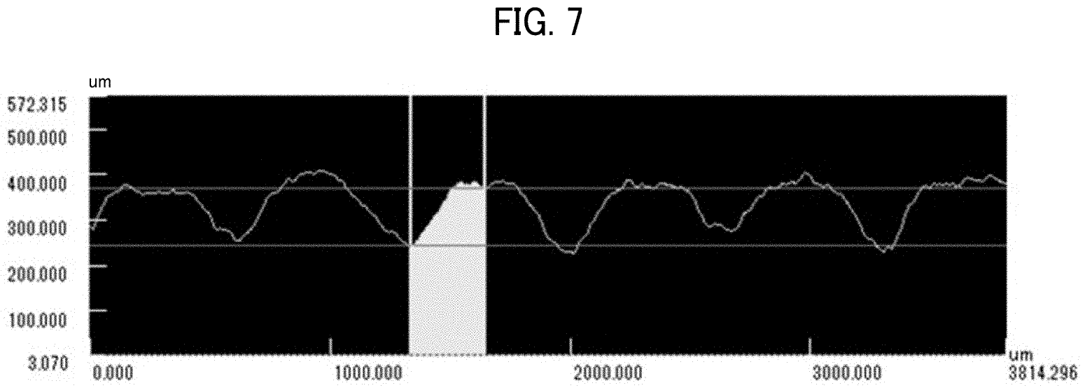

FIG. 7 is a graph plotting an example of the thickness profile of regions to which the volume expansion suppressor was applied and regions to which the volume expansion suppressor was not applied in the volume expansion layer of the printed matter 4 produced in Example 4. In FIG. 7, the vertical axis represents the thickness (unit: micrometer) of the volume expansion layer, and the horizontal axis represents the position in the volume expansion layer in the horizontal direction (unit: micrometer). The profile plotted in FIG. 7 is a thickness profile in a cross section including the center portions of the regions to which the volume expansion suppressor was applied (i.e., near the most recessed positions of the recesses).

As plotted in FIG. 7, it can be seen that a plurality of recesses having appropriately the same size (depth) were formed in the printed matter 4 produced in Example 4 in a range of 4,000 micrometers in the horizontal direction.

The average thickness of the regions to which the volume expansion suppressor was applied in the volume expansion layer of the printed matter 4 was 318 micrometers, and the average thickness of the regions to which the volume expansion suppressor was not applied in the volume expansion layer of the printed matter 4 was 420 micrometers. Hence, in Example 4, volume expansion of the regions to which the volume expansion suppressor was applied was suppressed by 102 micrometers on the average compared with the regions to which the volume expansion suppressor was not applied, and a printed matter having a height difference of 102 micrometers was produced.

### Example 5

A printed matter 5 was produced in the same manner as in Example 4, except that unlike in Example 4, the discharging frequency was changed to 3.6 kHz (three times higher than in Example 4).

A thickness profile of the volume expansion layer of the printed matter 5 was obtained in the same manner as in Example 1, and the average thicknesses of the regions to which the volume expansion suppressor was applied and the regions to which the volume expansion suppressor was not applied in the volume expansion layer were measured respectively.

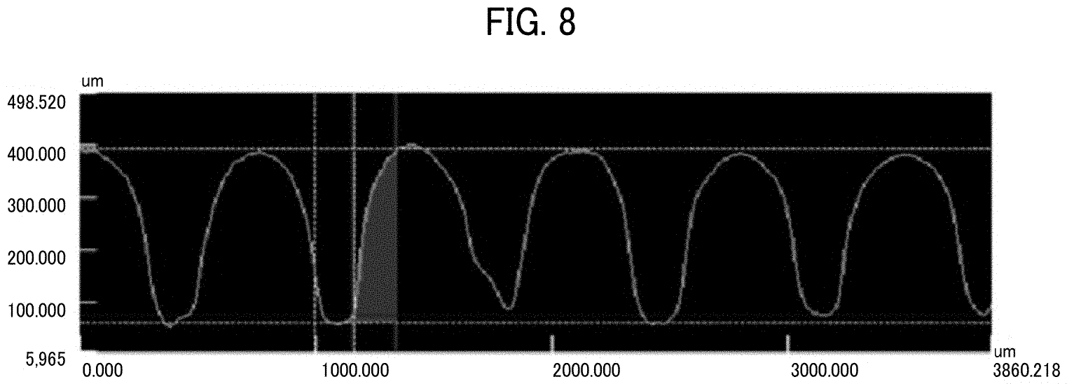

FIG. 8 is a graph plotting an example of the thickness profile of regions to which the volume expansion suppressor was applied and regions to which the volume expansion suppressor was not applied in the volume expansion layer of the printed matter 5 produced in Example 5. In FIG. 8, the vertical axis represents the thickness (unit: micrometer) of the volume expansion layer, and the horizontal axis represents the position in the volume expansion layer in the horizontal direction (unit: micrometer). The profile plotted in FIG. 8 is a thickness profile in a cross section including the center portions of the regions to which the volume expansion suppressor was applied (i.e., near the most recessed positions of the recesses).

As plotted in FIG. 8, it can be seen that a plurality of recesses having a different shape from Example 4 were formed in the printed matter 5 produced in Example 5 in a range of 4,000 micrometers in the horizontal direction.

The average thickness of the regions to which the volume expansion suppressor was applied in the volume expansion layer of the printed matter 5 was 115 micrometers, and the average thickness of the regions to which the volume expansion suppressor was not applied in the volume expansion layer of the printed matter 5 was 425 micrometers. Hence, in Example 5, volume expansion of the regions to which the volume expansion suppressor was applied was suppressed by 310 micrometers on the average compared with the regions to which the volume expansion suppressor was not applied, and a printed matter having a height difference of 310 micrometers was produced.

### Example 6

A printed matter 6 was produced in the same manner as in Example 1, except that unlike in Example 1, the volume expansion layer forming liquid 1 was changed to a volume expansion layer forming liquid 2 prepared in the manner described below.

### <Preparation of Volume Expansion Layer Forming Liquid 2>

KUREHA MICROSPHERE (obtained from KUREHA Corporation, H750) serving as a volume expansion agent (15 parts by mass), isobornyl acrylate (SR506, obtained from Tomoe Engineering Co., Ltd.) serving as a polymerizable solvent (polymerizable compound) (50 parts by mass), 2-acryloyloxypropyl phthalic acid (ACB-21, obtained from Shin-Nakamura Chemical Co., Ltd.)(50 parts by mass), and OMNIRAD TPO (obtained from IGM Resins B.V.) serving as a polymerization initiator (5 parts by mass) were stirred, to prepare a volume expansion layer forming liquid 2.

The static surface tension and the viscosity of the volume expansion layer forming liquid 2 at 25 degrees C. measured in the same manner as measuring the volume expansion layer forming liquid 1 were 33.5 mN/m and 130 mPa·s.

The average thicknesses of the regions to which the volume expansion suppressor was applied and the regions to which the volume expansion suppressor was not applied in the volume expansion layer of the printed matter 6 were measured respectively in the same manner as in Example 1.

The average thickness of the regions to which the volume expansion suppressor was applied in the volume expansion layer of the printed matter 6 was 190 micrometers, and the average thickness of the regions to which the volume expansion suppressor was not applied in the volume expansion layer of the printed matter 6 was 410 micrometers. Hence, in Example 6, volume expansion of the regions to which the volume expansion suppressor was applied was suppressed by 220 micrometers on the average compared with the regions to which the volume expansion suppressor was not applied, and a printed matter having a height difference of 220 micrometers was produced.

### Examples 7 to 14

Printed matters 7 to 14 were produced in the same manner as in Example 1, except that unlike in Example 1, the pattern according to which the volume expansion suppressor was discharged was changed to a solid (uniform) pattern, the composition of the volume expansion layer forming liquid was changed to as presented in Table 1 below, and the average thickness of the volume expansion layer forming liquid applied with the coating roller 10 was changed to 150 micrometers.

TABLE 1

| | Isobornyl | 2-Acryloyloxypropyl | KUREHA | OMNIRAD | BYK-UV |
|---|---|---|---|---|---|
| | acrylate | phthalic acid | MICROSPHERE | TPO | 3510 |
| | (part by mass) | (part by mass) | (part by mass) | (part by mass) | (% by mass) |
| Ex. 7 | 50 | 50 | 15 | 5 | 0.1 |
| Ex. 8 | 10 | 50 | 9 | 3 | — |
| Ex. 9 | 10 | 100 | 16.5 | 5.5 | — |
| Ex. 10 | 100 | 50 | 22.5 | 7.5 | 0.1 |
| Ex. 11 | 10 | 100 | 16.5 | 5.5 | 0.1 |
| Ex. 12 | 100 | 10 | 16.5 | 5.5 | — |
| Ex. 13 | 50 | 50 | 16.35 | 5.45 | — |
| Ex. 14 | 50 | 50 | 15 | 5 | 1.2 |

The components described below were used in Examples 7 to 14.
Isobornyl acrylate: SR506 (obtained from Tomoe Engineering Co., Ltd.)
2-Acryloyloxypropyl phthalic acid: ACB-21 (obtained from Shin-Nakamura Chemical Co., Ltd.)
KUREHA MICROSHERE: H750 (obtained from KUREHA Corporation)
OMNIRAD TPO (obtained from IGM Resins B.V.)
BYK-UV 3510(BYK (obtained from Byk-Chemie Japan K.K., a surface tension modifier)

In Table 1 above, the values in the columns of isobornyl acrylate, 2-acryloyloxypropyl phthalic acid, KUREHA MICROSPHERE, and OMNIRAD TPO mean values in part by mass, and the values in the column of BYK-UV 3510 mean values in % by weight relative to the total amount of the volume expansion layer forming liquid.

The static surface tension and the viscosity of the volume expansion layer forming liquids of the printed matters 7 to 14 produced in Examples 7 to 14 were measured in the same manner as measuring the volume expansion layer forming liquid 1. The results are presented in Table 2. In Table 2, the static surface tension of the volume expansion layer forming liquids at 25 degrees C. is presented as static surface tension A, the static surface tension (35.7 mN/m) of the volume expansion suppressor 1 at 25 degrees C. is presented as static surface tension B, and the absolute value of the difference between the static surface tension A and the static surface tension B is presented as |A−B|.

The average thicknesses of the regions to which the volume expansion suppressor was applied and the regions to which the volume expansion suppressor was not applied in the volume expansion layer of the printed matters 7 to 14 produced in Examples 7 to 14 were measured respectively in the same manner as in Example 1, to calculate the difference (height difference) between the average thickness of the regions to which the volume expansion suppressor was applied and the average thickness of the regions to which the volume expansion suppressor was not applied. The results are presented in Table 2.

### <Evaluation>

Next, the printed matters 7 to 14 produced in Examples 7 to 14 were visually observed to perform overall evaluation according to the criteria described below. The ratings B and A are non-problematic levels for practical use. The results are presented in Table 2.

### [Evaluation Criteria of Overall Evaluation]

A: The boundaries between the bosses and recesses of the bossed-recessed shape were recognizable when the printed matter was placed on a horizontal place apart by 1.5 m and observed from a position at an angle of 60 degrees from the horizontal direction of the printed matter (i.e., a direction perpendicular to the thickness direction).

B: The boundaries between the bosses and recesses of the bossed-recessed shape were recognizable when the printed matter was placed on a horizontal place apart by 1.5 m and observed from a position at an angle of 45 degrees from the horizontal direction of the printed matter (i.e., a direction perpendicular to the thickness direction), but were not recognizable when the printed matter was observed from a position at an angle of 60 degrees.

C: The boundaries between the bosses and recesses of the bossed-recessed shape were recognizable when the printed matter was placed on a horizontal place apart by 1.5 m and observed from a position at an angle of 30 degrees from the horizontal direction of the printed matter (i.e., a direction perpendicular to the thickness direction), but were not recognizable when the printed matter was observed from a position at an angle of 45 degrees.

D: The boundaries between the bosses and recesses of the bossed-recessed shape were not recognizable when the printed matter was placed on a horizontal place apart by 1.5 m and observed from a position at an angle of 30 degrees from the horizontal direction of the printed matter (i.e., a direction perpendicular to the thickness direction).

TABLE 2

| | | Static surface | | Height | |
|---|---|---|---|---|---|
| | Viscosity | tension A | \|A − B\| | difference | Overall |
| | (mPa · s) | (mN/m) | (mN/m) | (micrometer) | evaluation |
| Ex. 7 | 170 | 27.9 | 7.8 | 106 | B |
| Ex. 8 | 5,300 | 34.7 | 1 | 56 | B |
| Ex. 9 | 7,200 | 35 | 0.7 | 36 | B |
| Ex. 10 | 5,300 | 27.9 | 7.8 | 53 | B |
| Ex. 11 | 7,200 | 27.5 | 8.2 | 33 | B |
| Ex. 12 | 13 | 31.4 | 4.3 | 327 | A |
| Ex. 13 | 170 | 33.5 | 2.2 | 250 | A |
| Ex. 14 | 160 | 25.5 | 10.2 | 5 | C |

Subsequently, the printed matter 13 produced in Example 13 was cut in the thickness direction of the printed matter 13 in a manner that a region to which the volume expansion suppressor was applied and a region to which the volume expansion suppressor was not applied were included, and an image of the obtained cross-section was captured with AXIO IMAGER ZEM (obtained from Carl ZEISS Co., Ltd.).

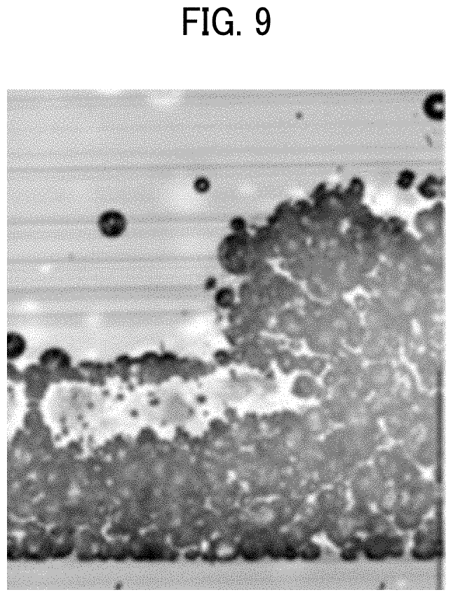

FIG. 9 illustrates the captured image of the cross-section of the printed matter 13 produced in Example 13 taken in the thickness direction.

In FIG. 9, the left-hand side is the region (printed portion) to which the volume expansion suppressor was applied, and the right-hand side is the region (non-printed portion) to which the volume expansion suppressor was not applied. It can be seen that the region to which the volume expansion suppressor was applied at the left-hand side of FIG. 9 has a cured product of the volume expansion suppressor at the top (shallower side) of the volume expansion layer and the volume expansion agent suppressed from volume expansion (foaming) was scattered on the cured product of the volume expansion suppressor.

Hence, the region to which the volume expansion suppressor was applied and the region to which the volume expansion suppressor was not applied in the volume expansion layer were easily discernable by observation of the cross-section of the volume expansion layer.

Hence, as described above, the printed matter producing method of the present disclosure includes a volume expansion layer forming step of forming a volume expansion layer containing a volume expansion agent, a volume expansion suppressor applying step of applying and contacting a volume expansion suppressor containing a multifunctional monomer to the volume expansion layer while increasing the amount of the multifunctional monomer to be applied to a predetermined region of the volume expansion layer in accordance with the degree of suppressing volume expansion of the predetermined region of the volume expansion layer, and a volume expanding step of heating the volume expansion layer after the volume expansion suppressor applying step to volume-expand the volume expansion layer.

Hence, the printed matter producing method of the resent disclosure can produce a printed matter having a desired bossed-recessed shape.

Aspects of the present disclosure are, for example, as follows.

<1> A printed matter producing method including:

forming a volume expansion layer containing a volume expansion agent;

applying and contacting a volume expansion suppressor containing a multifunctional monomer to the volume expansion layer while increasing an amount of the multifunctional monomer to be applied to a predetermined region of the volume expansion layer in accordance with a degree of suppressing volume expansion of the predetermined region of the volume expansion layer; and

heating the volume expansion layer after the applying to volume-expand the volume expansion layer.

<2> The printed matter producing method according to <1>,

wherein in the applying, the volume expansion suppressor is discharged by an inkjet method and applied to the volume expansion layer.

<3> The printed matter producing method according to <2>,

wherein the amount of the multifunctional monomer to be applied to the predetermined region of the volume expansion layer is controlled by control on a number of times to apply the volume expansion suppressor to the predetermined region of the volume expansion layer.

<4> The printed matter producing method according to <3>,

wherein the number of times to apply the volume expansion suppressor is controlled by control on a discharging frequency at which the volume expansion suppressor is discharged by the inkjet method.

<5> The printed matter producing method according to <3>,

wherein the number of times to apply the volume expansion suppressor is controlled by control on a pattern of discharging pulses by which the volume expansion suppressor is discharged by the inkjet method.

<6> The printed matter producing method according to any one of <1> to <5>,

wherein the amount of the multifunctional monomer to be applied to the predetermined region of the volume expansion layer is controlled by control on a discharging amount of the volume expansion suppressor per liquid droplet when the volume expansion suppressor is discharged to the predetermined region of the volume expansion layer.

<7> The printed matter producing method according to any one of <1> to <6>,

wherein when applying the volume expansion suppressor to the predetermined region of the volume expansion layer by discharging the volume expansion suppressor to each unit area of the predetermined region, the discharging amount of the volume expansion suppressor per the unit area is varied between a plurality of the unit area adjacent to each other.

<8> The printed matter producing method according to <7>,

wherein when a total discharging amount of the volume expansion suppressor to be discharged to two unit areas adjacent to each other in the predetermined region of the volume expansion layer is 2X, the discharging amount of the volume expansion suppressor is controlled in a manner that the discharging amount of the volume expansion suppressor to be discharged to one of the two unit areas adjacent to each other is 0.5X or less.

<9> The printed matter producing method according to any one of <1> to <8>,

wherein an amount of the volume expansion suppressor to be applied to the predetermined region of the volume expansion layer in the applying is set to 0.01 microliters/cm² or greater but 8 microliters/cm² or less with respect to a surface of the volume expansion layer.

<10> The printed matter producing method according to anyone of <1> to <9>,

wherein in the applying, the amount of the multifunctional monomer to be applied to the predetermined region of the volume expansion layer is controlled by application of any of a plurality of the volume expansion suppressor having different concentrations of the multifunctional monomer selected in accordance with the degree of suppressing volume expansion of the predetermined region of the volume expansion layer.

<11> The printed matter producing method according to any one of <1> to <10>

wherein in the forming, the volume expansion layer is formed by application of a volume expansion layer forming liquid containing the volume expansion agent over a base material and subsequent curing of the volume expansion layer forming liquid.

<12> The printed matter producing method according to <11>,

wherein in the forming and the applying, the volume expansion layer is formed by application of the volume expansion suppressor over a layer of the volume expansion layer forming liquid and subsequent curing of the volume expansion layer forming liquid.

<13> The printed matter producing method according to <1> or <12>,

wherein a viscosity of the volume expansion layer forming liquid at 25 degrees C. is 50 mPa·s or higher but 10,000 mPa·s or lower.

<14> The printed matter producing method according to any one of <11> to <13>,

wherein a static surface tension A of the volume expansion layer forming liquid at 25 degrees C. and a static surface tension B of the volume expansion suppressor at 25 degrees C. satisfy an inequality: |A−B|≤6 mN/m.

<15> The printed matter producing method according to anyone of <1> to <14>,

wherein the volume expansion agent is a thermally expansible microcapsule.

<16> A printed matter producing apparatus including:

a volume expansion layer forming unit configured to form a volume expansion layer containing a volume expansion agent;

a volume expansion suppressor applying unit configured to apply and contact a volume expansion suppressor containing a multifunctional monomer to the volume expansion layer while increasing an amount of the multifunctional monomer to be applied to a predetermined region of the volume expansion layer in accordance with a degree of suppressing volume expansion of the predetermined region of the volume expansion layer; and

a volume expanding unit configured to heat the volume expansion layer after the volume expansion suppressor applying unit applies the volume expansion suppressor to volume-expand the volume expansion layer.

The printed matter producing method according to any one of <1> to <15> and the printed matter producing apparatus according to <16> can solve the various problems in the related art and achieve the object of the preset disclosure.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A printed matter producing method comprising:
forming a volume expansion layer containing a volume expansion agent;
applying and contacting a volume expansion suppressor containing a multifunctional monomer to the volume expansion layer while increasing an amount of the multifunctional monomer to be applied to a predetermined region of the volume expansion layer in accordance with a degree of suppressing volume expansion of the predetermined region of the volume expansion layer; and
heating the volume expansion layer after the applying to volume-expand the volume expansion layer.

2. The printed matter producing method according to claim 1,
wherein in the applying, the volume expansion suppressor is discharged by an inkjet method and applied to the volume expansion layer.

3. The printed matter producing method according to claim 2,
wherein the amount of the multifunctional monomer to be applied to the predetermined region of the volume expansion layer is controlled by control on a number of times to apply the volume expansion suppressor to the predetermined region of the volume expansion layer.

4. The printed matter producing method according to claim 3,
wherein the number of times to apply the volume expansion suppressor is controlled by control on a discharging frequency at which the volume expansion suppressor is discharged by the inkjet method.

5. The printed matter producing method according to claim 3,
wherein the number of times to apply the volume expansion suppressor is controlled by control on a pattern of discharging pulses by which the volume expansion suppressor is discharged by the inkjet method.

6. The printed matter producing method according to claim 1,
wherein the amount of the multifunctional monomer to be applied to the predetermined region of the volume expansion layer is controlled by control on a discharging amount of the volume expansion suppressor per liquid droplet when the volume expansion suppressor is discharged to the predetermined region of the volume expansion layer.

7. The printed matter producing method according to claim 1,
wherein when applying the volume expansion suppressor to the predetermined region of the volume expansion layer by discharging the volume expansion suppressor to each unit area of the predetermined region, the discharging amount of the volume expansion suppressor per the unit area is varied between a plurality of the unit area adjacent to each other.

8. The printed matter producing method according to claim 7,
wherein when a total discharging amount of the volume expansion suppressor to be discharged to two unit areas adjacent to each other in the predetermined region of the volume expansion layer is 2X, the discharging amount of the volume expansion suppressor is controlled in a manner that the discharging amount of the volume expansion suppressor to be discharged to one of the two unit areas adjacent to each other is 0.5X or less.

9. The printed matter producing method according to claim 1,
wherein an amount of the volume expansion suppressor to be applied to the predetermined region of the volume expansion layer in the applying is set to 0.01 microliters/cm² or greater but 8 microliters/cm² or less with respect to a surface of the volume expansion layer.

10. The printed matter producing method according to claim 1,
wherein in the applying, the amount of the multifunctional monomer to be applied to the predetermined region of the volume expansion layer is controlled by application of any of a plurality of the volume expansion suppressor having different concentrations of the multifunctional monomer selected in accordance with the degree of suppressing volume expansion of the predetermined region of the volume expansion layer.

11. The printed matter producing method according to claim 1,
wherein in the forming, the volume expansion layer is formed by application of a volume expansion layer forming liquid containing the volume expansion agent over a base material and subsequent curing of the volume expansion layer forming liquid.

12. The printed matter producing method according to claim 11,
wherein in the forming and the applying, the volume expansion layer is formed by application of the volume expansion suppressor over a layer of the volume expansion layer forming liquid and subsequent curing of the volume expansion layer forming liquid.

13. The printed matter producing method according to claim 11,
wherein a viscosity of the volume expansion layer forming liquid at 25 degrees C. is 50 mPa·s or higher but 10,000 mPa·s or lower.

14. The printed matter producing method according to claim 11,
wherein a static surface tension A of the volume expansion layer forming liquid at 25 degrees C. and a static surface tension B of the volume expansion suppressor at 25 degrees C. satisfy an inequality: |A−B|≤6 mN/m.

15. The printed matter producing method according to claim 1,
wherein the volume expansion agent is a thermally expansible microcapsule.

16. A printed matter producing apparatus comprising:
a volume expansion layer forming unit configured to form a volume expansion layer containing a volume expansion agent;
a volume expansion suppressor applying unit configured to apply and contact a volume expansion suppressor containing a multifunctional monomer to the volume expansion layer while increasing an amount of the multifunctional monomer to be applied to a predetermined region of the volume expansion layer in accordance with a degree of suppressing volume expansion of the predetermined region of the volume expansion layer; and
a volume expanding unit configured to heat the volume expansion layer after the volume expansion suppressor applying unit applies the volume expansion suppressor to volume-expand the volume expansion layer.
